(19) United States
(12) Patent Application Publication
(10) Pub. No.: US 2026/0298892 A1
(43) Pub. Date: Oct. 1, 2026

(54) CORRECTING DRIFT EFFECTS IN LC-MS DATA BASED ON RETENTION TIME

(71) Applicant: Donald Danforth Plant Science Center, St. Louis, MO (US)

(72) Inventors: Allen Hubbard, St. Louis, MO (US); Louis Connelly, St. Louis, MO (US); Ivan Baxter, St. Louis, MO (US); Bradley Evans, St. Louis, MO (US)

(21) Appl. No.: 19/489,350

(22) PCT Filed: May 31, 2024
(86) PCT No.: PCT/US2024/031826

§ 371 Date: Dec. 2, 2025

Related U.S. Application Data
(60) Provisional application No. 63/505,952, filed on Jun. 2, 2023.

(51) Int. Cl. G01N 30/86; G01N 30/02; G01N 30/72

(52) U.S. Cl. CPC G01N 30/8631; G01N 30/7233; G01N 2030/027

(57) ABSTRACT

Systems and methods for correcting drift in retention times of compound signals in chromatography-MS are provided. The methods can correct signals in chromatography-MS data on a compound-by-compound basis. Additionally, the invention includes mechanisms to distinguish between true drift and isomer presence, ensuring that isomers are not incorrectly merged, thereby preserving the integrity of the data. Importantly, the strategy is executable in parallel, thereby allowing a balance of scalability and accuracy not available in currently existing strategies.

### CROSS-REFERENCE TO RELATED APPLICATIONS

This application claims priority from Provisional Application No. 63/505,952, filed Jun. 2, 2023, the entire contents of which are hereby incorporated by reference.

### GOVERNMENTAL RIGHTS

This invention was made with government support under DE-SC0018277 and DE-SC0023160 awarded by the Department of Energy. The government has certain rights in the invention.

### FIELD OF THE INVENTION

The present disclosure relates generally to compound detection. More specifically, the present disclosure relates to amplification and detection of compound signals.

### BACKGROUND OF THE INVENTION

Liquid chromatography-mass spectrometry (LC-MS) is a chemical technique that identifies different compounds in a sample as unique mass features. A liquid chromatography system can separate the different compounds by structural properties, while a mass spectrometer subsequently determines the mass and intensity of the ions that elute from the chromatography column. Modern high-resolution mass spectrometry can now detect and quantify ions with high mass precision (<5 ppm mass error), but can also result in significant amounts of noise.

Detecting valid compound peaks within mass spectrometry data can present a number of challenges when the compound can only be present at low levels relative to noise. For example, samples from complex systems can include large numbers of different compounds, some of which can only be present in relatively low quantities. A typical mass spectrometry file can contain as many as millions of data points, while as few as several hundred to thousands can correspond to true compound signals that are interspersed in vast amounts of noise.

To complicate the detection of compound peaks even further, compounds can have a mass-to-charge (m/z) signal value that has a drift in retention time. For example, the retention time instrumentation can be off when a batch within the course of experiments/runs is processed. This results in drift of the intensity signal value in the retention time domain (e.g., a shift in signal to an earlier or later time).

Such compound signals and the retention time shifts are generally analyzed computationally by aligning all the signals for various metabolites at once, or in large chunks that improperly treat metabolites with disparate characteristics the same. In other words, current techniques attempt to match all compound signals simultaneously. However, this approach introduces warping effects because drift isn't being corrected for on an individual basis for each unique compound. Especially problematic is when a metabolite's signal is close to another metabolite, with each one experiencing its own unique chromatography drift. Such methods end up discarding valid compound signals, as well as being computationally expensive and slow.

Thus, there is a need for improved systems and methods correcting drift in retention times of metabolite signals.

### SUMMARY OF THE INVENTION

One embodiment of the instant disclosure encompasses a method for correcting drift in retention times of compound signals in chromatography-mass spectrometry (chromatography-MS) data. The method comprises (a) splitting a reference extracted ion chromatogram (EIC) of a portion of an MS chromatogram selected from a plurality of EICs into a plurality of time increments, wherein each of the plurality of EICs contains a mass-to-charge (m/z) signal feature that bears the same m/z value; (b) for each remaining EIC, generating a query EIC by shifting the data points of the query EIC by a first time increment of the plurality of time increments; (c) determining a first subset of data points of the query EIC as the data points outside an intersection of data points between the reference EIC and the query EIC and a second subset of data points of the query EIC as the data points intersecting data points between the reference EIC and the query EIC; (d) generating a scoring function value based on the first subset of data points, a scoring function value based on the second subset of data points, or both subsets of data points; (e) iteratively repeating steps (b) to (d) by shifting the data points of the query EIC by the plurality of time increments and generating a plurality of scoring function values; (f) determining the optimal time increment that corresponds to the drift of the m/z signal feature by minimizing the first scoring function value, maximizing the second scoring function value, or both; and (g) correcting the query EIC or the reference EIC by shifting the query EIC or the reference EIC by that time increment.

The reference EIC can be a merged EIC of two or more EICs of the plurality of EICs and a remaining EIC is an individual EIC among the plurality of EICs. The reference EIC can also be an individual EIC and a remaining EIC is an individual EIC among the plurality of EICs.

In some embodiments, the compound is metabolites, isomers of metabolites, or both. In some embodiments, the chromatography-MS is liquid chromatography-MS (LC-MS). In some embodiments, the method further comprises identifying or having identified an m/z value most likely to belong to a compound for which an EIC can be extracted. In some embodiments, the scoring function is based on the sum of the first subset of data points.

In some embodiments, the method further comprises: obtaining or having obtained one or more data files from a chromatography-mass spectrometry machine that has analyzed one or more samples of unknown compounds; and splitting the MS chromatograms into a plurality of EICs each containing a mass-to-charge (m/z) signal feature.

In some embodiments, the method comprises: generating a scoring function value based on the first subset of data points; determining the optimal time increment that corresponds to the drift of the m/z signal feature by minimizing the first scoring function value; and correcting the query EIC or the reference EIC by shifting the query EIC or the reference EIC by that time increment.

In some embodiments, the method further comprises using the scoring function value to determine if any pair of m/z signal features in an EIC are a compound and an isomer, a single isomer of the compound with drift, or noise or other artifacts. In some embodiments, using the scoring function value to determine if any pair of m/z signal features in an EIC are unique isomers or a single isomer of the compound with drift comprises: comparing subsets of files high in any pair of two peaks; identifying symmetrical features within the scoring function that indicate poor fit in both directions of the time increments; and determining that symmetrical scoring function values indicate the presence of isomers rather than drift. In other embodiments, using the scoring function value to determine if any pair of m/z signal features in an EIC are unique isomers or a single isomer of the compound with drift comprises: identifying the first m/z signal feature as a metabolite; determining the plurality of time increments that equally span both before and after the first m/z signal feature based on identifying the metabolite; incrementing through each time increment of the plurality of time increments to generate a scoring function, wherein the scoring function is generated from a plurality of scoring function values at each time increment; and determining the drift of the first m/z signal feature on a metabolite-by-metabolite basis by identifying a minimum scoring value in the scoring function.

In some embodiments, using the scoring function value to determine if any pair of m/z signal features in an EIC are unique isomers or a single isomer of the compound with drift comprises: determining a pair of scoring function values that correspond to symmetrical features within a scoring function; determining that the pair of scoring function values indicate a poor fit in both directions of the plurality of time increments, centered around the first m/z signal; and determining that the second m/z signal feature corresponds to an isomer rather than a drift in retention time based on the symmetrical features and poor fit in both directions. In some embodiments, the method further comprises excluding the isomer from the drift calculation and adjusting the compound peak and the isomer peak independently.

A method of the instant disclosure can further comprise determining a metric of similarity based on the scoring function, wherein the metric measures the probability that an optimal shift, which minimizes the average difference in the data points between the reference chromatogram and the query chromatogram, accurately represents the drift of the m/z signal feature rather than an isomer of a compound, or noise or other artifacts.

In some embodiments, the method further comprises addressing differential drift rates of isomers by: creating subsets of the highest files with data in each isomer peak;
comparing the signal distribution for each peak in the subsets to determine if the peaks are artifacts of drift; merging peaks by shifting the data points of one peak to align with another if they are determined to be the same compound experiencing drift, ensuring that the shift does not increase mismatches in signal and improves the metric of similarity; and
iteratively assessing each pair of peaks to determine if they are artifacts of drift or unique isomers, where unique isomers will show signal in both subsets and merging them would worsen the metric of similarity.

In some embodiments, the method further comprises generating query chromatograms for each m/z signal feature within the portion of the reference chromatogram and determining the time increment that corresponds to the drift of each m/z signal feature concurrently on different processors.

Another embodiment of the instant disclosure encompasses a computing system for correcting drift in retention times of compound signals in chromatography-mass spectrometry (chromatography-MS) data. The computing system of the instant disclosure comprises a communication interface and a processor. The communication interface can receive EICs of portions of each of a plurality of MS chromatograms, wherein the portions of the plurality of chromatograms bear the same m/z value. The processor can execute instructions stored in memory. In some embodiments, the processor executes the instructions to correct drift in retention times of compound signals in chromatography-mass spectrometry (chromatography-MS) data. Correcting drift in retention times of compound signals in chromatography-MS data can be as described herein above.

Yet another embodiment of the instant disclosure encompasses a non-transitory, computer-readable storage medium, having embodied thereon a program executable by a processor to perform a method for correcting drift in retention times of compound signals in chromatography-mass spectrometry (chromatography-MS) data. In some embodiments, the method can be as described herein above.

### BRIEF DESCRIPTION OF THE FIGURES

The following drawings form part of the present specification and are included to further demonstrate certain embodiments of the present disclosure. Certain embodiments can be better understood by reference to one or more of these drawings in combination with the detailed description of specific embodiments presented herein.

FIG. 1 illustrates an exemplary mass spectrometry dataset before retention time correction has been applied, in accordance with example embodiments.

FIG. 2 illustrates an exemplary retention time shift in the mass spectrometry dataset, in accordance with example embodiments.

FIG. 3 illustrates an exemplary retention time shift determination using a mass spectrometry dataset, in accordance with example embodiments.

FIG. 4 illustrates an exemplary isomer feature in the mass spectrometry dataset, in accordance with example embodiments.

FIG. 5A illustrates an exemplary isomer swap in the mass spectrometry dataset, in accordance with example embodiments.

FIG. 5B illustrates an exemplary isomer swap in the mass spectrometry dataset, in accordance with example embodiments.

FIG. 6 illustrates a correct alignment in the mass spectrometry dataset, in accordance with example embodiments.

FIG. 7 illustrates exemplary scoring function values when isomers are properly aligned, in accordance with example embodiments.

FIG. 8 illustrates an exemplary mass spectrometry dataset associated with a certain compound before and after retention time correction has been applied, in accordance with example embodiments.

FIG. 9 illustrates an exemplary mass spectrometry dataset associated with isomer preservation before and after retention time correction has been applied, in accordance with example embodiments.

FIG. 10 illustrates an exemplary example to correct for isomer swapping, in accordance with example embodiments.

FIG. 11 illustrates an exemplary example of m/z signal feature in a mass spectrometry dataset associated with a single extracted ion chromatogram, derived from multiple isomers which exhibit unique retention time drift, before retention time correction has been applied, in accordance with example embodiments.

FIG. 12 illustrates a signal distribution for multiple isomers associated with a single extracted ion chromatogram, each isomer of which exhibits a unique retention time drift, but subsetted by only the highest files with each m/z signal feature in accordance with example embodiments. FIG. 12 captures the fact that if signal A and A′ are indeed a single isomer resulting from drift, samples high in A will be low in A′ and vice versa (samples high in A′ will be low in A).

FIG. 13 illustrates a signal distribution for multiple isomers associated with a single extracted ion chromatogram, each isomer of which exhibits a unique retention time drift, once the isomer specific drift has been corrected for, in accordance with example embodiments.

FIG. 14 illustrates a signal distribution for multiple isomers associated with a single extracted ion chromatogram after the isomer specific drift has been corrected for, with A′ having been merged into A, but before examining whether the merged A′→A isomer can be further merged with isomer B, in accordance with example embodiments.

FIG. 15 illustrates that samples high in B are also high in the merged isomer A′→A, showing that this isomer B should not be additionally merged, in accordance with example embodiments. If such a merging shift were to be implemented, it would receive a poor scoring value.

FIG. 16 describes how iteratively implementing the scoring function on potential isomers can distinguish those likely to be unique isomers (i.e. B) vs artifacts of other isomers created via drift (A and A′) in accordance with example embodiments.

FIG. 17 demonstrates how incorrectly merging an isomer (B) as if it were and artifact of drift with other isomers, creates a mismatch that is detected by the scoring function in accordance with example embodiments.

FIG. 18 illustrates an example of a computing system to correct for drift, in accordance with example embodiments.

### DETAILED DESCRIPTION

Embodiments of the present disclosure include systems and methods for correcting for retention time drift of MS mass features for the amplification and detection of MS signals. The inventors devised methods for correcting drift in retention times of metabolite signals in chromatography-MS data on a compound-by-compound basis. Unlike existing techniques that attempt to align all compound signals simultaneously, which can introduce warping effects and are computationally expensive, this invention splits a portion of a reference chromatogram into a plurality of retention time increments and generates query chromatograms by shifting data points incrementally. By evaluating each possible shift value using a scoring methodology, methods of the instant disclosure determine an optimal shift value that minimizes mismatches with the reference chromatogram. This approach allows for more accurate and efficient correction of drift, even when metabolites are close to each other and experience unique chromatography drift. Additionally, the invention includes mechanisms to distinguish between true drift and isomer presence, ensuring that isomers are not incorrectly merged, thereby preserving the integrity of the data. Importantly, the strategy is executable in parallel, thereby allowing a balance of scalability and accuracy not available in currently existing strategies.

### I. Method

Embodiments of the present disclosure encompass systems and methods for the amplification and detection of compound signals. A plurality of m/z signal intensities can be captured by a mass spectrometer in an output file. Mass-to-charge ratio (m/z) data describes the mass-to-charge ratio of an ion deriving from a measurable compound, while intensity data records the abundance of a species of a given m/z and retention time. Each output file can include signals associated with mass measurements of compounds in a respective sample, as well as retention time information that can be represented in a chromatogram. The datasets of the output files can be combined into a merged file of m/z signal intensities, which can also contain retention time data. A concentration of signals can be identified in the merged m/z signal-intensities following a specified statistical distribution and determined to be indicative of a compound of specific m/z when the concentration of signals corresponds to one or more mass measurements associated with the compound and an isomer of the compound. Isomers are chemically identical to the compound, except for a change in the compound's structure.

Thus, the difference in retention time between the compound and its corresponding isomer is based on its unique structure.

### (a) Method Steps

One embodiment of the present disclosure encompasses a method for the amplification and detection of compound signals. According to methods of the instant disclosure, a plurality of m/z signal intensities captured by a mass spectrometer in an output file can be obtained. Mass-to-charge ratio (m/z) data describes the mass-to-charge ratio of an ion deriving from a measurable compound, while intensity data records the abundance of a species of a given m/z and retention time. Each output file can include signals associated with mass measurements of compounds in a respective sample, as well as retention time information that can be represented in a chromatogram.

In some embodiments, chromatography-mass spectrometry (chromatography-MS) can be used for untargeted analyses of chemical, biochemical, and metabolomic compounds. See Section I(b) for additional detail. While specific types of compounds (e.g., metabolites, citrulline) can be discussed herein, such discussion of specific embodiments is for illustrative purposes and should not be interpreted as limiting the present disclosure to the specific embodiments being illustrated and discussed. In order to harness the sensitivity of LC-MS while avoiding associated noise and retention time drift, embodiments of the present disclosure separate true and valid signals indicative of the compound from noise using a retention time shift to align signals that experience drift. Various embodiments can amplify compound signals by combining a plurality of m/z signal intensity files together after shifting for a determined retention time shift. Such combination can also result in the amplification of the associated compound signals, as well as associated isomer signals.

Each metabolite m/z value can have retention time data that experiences drift during the collection of a chromatogram. For example, a batch that came at some point throughout the course of experiments/runs where the retention time instrumentation was a little off can result in drift (e.g., a shift in signal to an earlier or later time). Since the detection of a signal can be challenging due to noise within the chromatogram, all the signals corresponding to a certain compound need to be aggregated together to get a strong signal result. Therefore, if portions of the signals are off—e.g., a shift due to drift—then there is a need to pick up on the shift and correct for it, so that the entire signal is concentrated in a single peak of the chromatogram. This can amplify the signal above noise levels, allowing for the detection of compounds corresponding to signals that can have otherwise been lost within the noise.

The existing strategy is to align all the signals at once, instead of on a signal-by-signal basis. This can result in warping effects because drift is not being corrected for on an individual basis. Especially problematic is when a metabolite is close to another one, each one experiencing its own drift. The current technique would try to match them simultaneously. But if drift varies across metabolites, the correction would be poor across many of the metabolites within the chromatogram. Moreover, this process is slow and takes up many compute resources, as aligning all the signals at once involves processing the entire dataset within a chromatogram.

The technique herein for retention time drift correction implements, by contrast, retention time correction on metabolite-by-metabolite basis. Employing retention time drift correction in this way results in rapid alignments. For example, the process will correct for drift for each metabolite individually. This means that not only will compute resources be needed for only the metabolites of interest, but the correction will be more accurate per drift. Other techniques discussed herein avoid shifts due to isomer swapping.

Therefore, systems and methods are disclosed for correcting drift in retention times of metabolite signals. For example, a portion of a reference chromatogram can be split into a number of time increments, each of the time increments including data points that contain a first m/z signal feature (e.g., a metabolite for detection). A query chromatogram can be generated by shifting the data points by each time increment. Query chromatograms can be incremented throughout some range of time values (e.g., incremented through +/−10 minutes in an example embodiment). For each query chromatogram, one subset of data points can correspond to an intersection of the data points between a reference chromatogram (non-shifted) and each query chromatogram. Another subset of data points can correspond to unmatched data—e.g., data points that belong to a second m/z signal feature that lies outside the intersection of data points. From this, a scoring function value can be generated based on a sum of the unmatched data (e.g., the second subset of data points). For instance, if the scoring function is based on the sum of the data points that lie outside the intersection of data points, minimization of the scoring function determines the time increment that corresponds to the drift of the second m/z signal feature in retention time. The reference chromatogram can then be corrected by shifting the query chromatogram by that time increment.

Non-limiting examples of methods that can be used to determine a scoring function in addition to calculating the sum of a subset of data points include using statistical measures such as the mean or median of the second subset of data points, which could provide a measure of central tendency for the mismatched data; incorporating weighted sums, where each data point in the second subset is assigned a weight based on the significance or relevance to the overall alignment, and the weighted sum is then reduced; and using machine learning algorithms to determine a scoring function that takes into account the distribution and pattern of the mismatched data points, potentially providing a more nuanced assessment of the alignment.

If the scoring function is based on a simple sum, the value could be the total intensity of all data points in the subset of data points, indicating the total amount of signal that is not aligned between the reference and query EICs. If a weighted sum is used, data points closer to the peak of the chromatogram could be given higher weights, as their alignment is more significant to the accurate identification of compounds, and the weighted sum of these points would be reduced. In a statistical approach, the scoring function could be the standard deviation of the retention times of the data points in the subset, with minimization of this value indicating a tighter clustering of mismatched data points around a central value, suggesting a more consistent drift that can be corrected. For a machine learning-based scoring function, features such as the shape, spread, and intensity distribution of the second subset could be inputs to a model that outputs a score representing the degree of misalignment, with the model trained to minimize this score for optimal alignment. Each of these methods provides a different perspective on the alignment of the EICs and could be used independently or in combination to refine the process of correcting for drift in retention times.

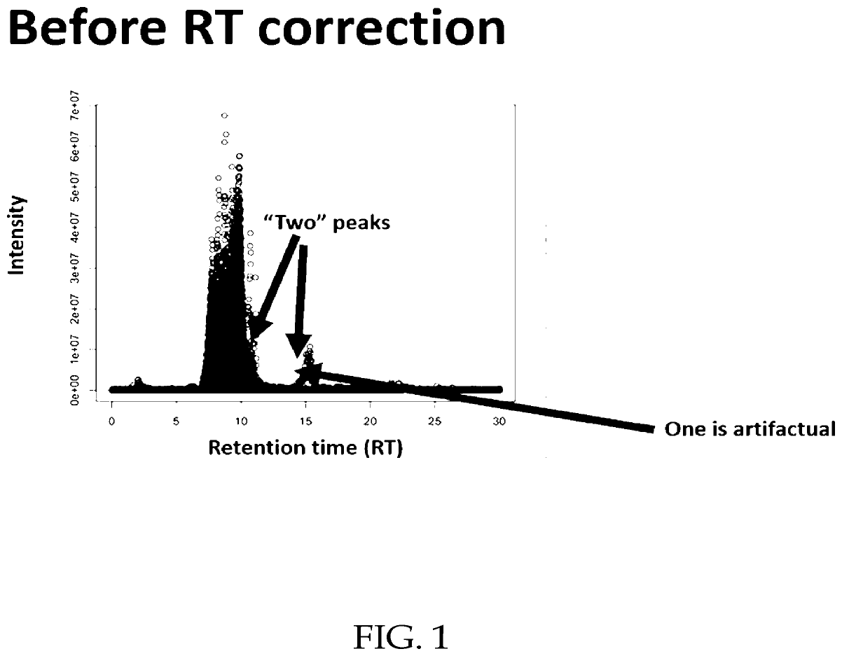

FIG. 1 illustrates an exemplary liquid chromatography mass spectrometry dataset before retention time correction has been applied, in accordance with example embodiments. For example, chromatograms such as the one shown in FIG. 1 can illustrate exemplary mass spectrometry datasets of different sizes and distributions associated with certain compounds. As illustrated, the differently sized data sets include different numbers of data points regarding mass spectrometry signals associated with mass measurements of compounds in a sample. While the signals generally fall into a specific distribution (e.g., Gaussian distribution), increasing the number of the data points obtained from plurality of pooled or merged m/z signal intensity files can also increase the prominence and detectability of the specific peak(s) amidst the surrounding noise. Each peak can correspond to a specific mass measurement of a compound, while noise can be more randomly distributed among many millions of detectable compound masses. As a result, when m/z signal intensities from many samples are combined together, the net noise levels can be reduced relative to the compound peaks resulting from aggregation of true and valid signals at a particular mass for the compound. As noise can be randomly distributed in each file of m/z signal intensities, the probability of observing multiple noise signals concentrated at a specific mass can be low to negligible, because the probability of getting noise at the exact m/z (e.g., measured to within 0.0001 of a single Dalton across a range of 1-1000 Daltons) and a high intensity more than once is extremely low in comparison to true and valid signals. Such difference can become even more prominent as the number of samples (and output data files thereof) increase. While the amount of noise signals can increase with more samples, this can be a slow and linear accumulation that can be far outpaced by exponential amplification of valid m/z signals that result from pooling samples into a merged spectra of m/z signal intensities. Importantly, because the production of noise signals can be a random process, the increased statistical power of a merged m/z signal intensities makes it possible to set accurate signal-to-noise thresholds via resampling based on permutation tests minimizes potential false positives. Thus, intensity measurements around signals representing true masses can therefore appear hyper-concentrated in peaks that follow a specific statistical (e.g., Gaussian or Lorentzian) distribution.

The example chromatogram shows retention time (RT) vs. intensity. In this case, the signal shows two peaks: the larger peak at around 9 minutes retention time and smaller peak at around 15 minutes retention time. However, the smaller peak is an artifact—this peak corresponds to the larger peak but has experienced drift during the course of data collection. The unaligned second peak weakens the intensity of the larger peak when combining with multiple samples, and can be especially problematic for metabolites with low signals that easily become lost within the noise levels.

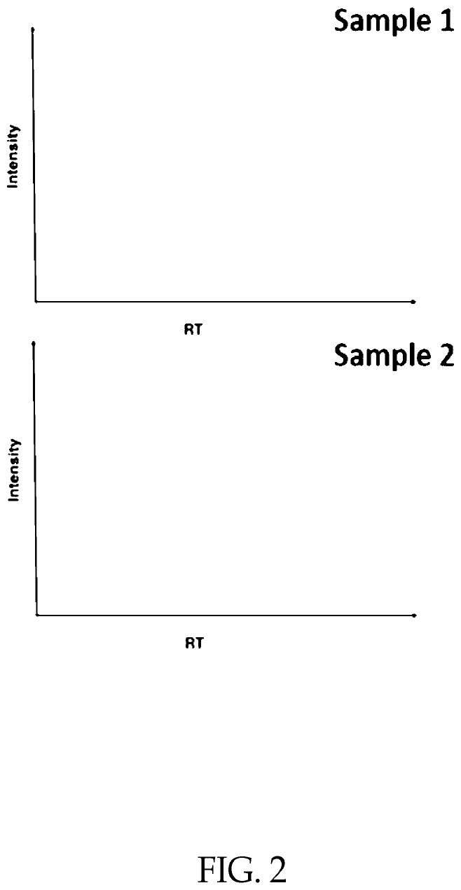

FIG. 2 illustrates a simplified exemplary shift in the mass spectrometry dataset, in accordance with example embodiments. Sample 1 is a first example chromatogram that shows retention time (RT) vs. intensity, and Sample 2 is a second example chromatogram that shows retention time (RT) vs. intensity. Sample 2 shows a shift of the peak in RT with respect to Sample 1. Assuming the peaks in Sample 1 and Sample 2 indicate the same metabolite signature, the peak in Sample 2 will need to be shifted to align with the peak in Sample 1, which will correct the drift in RT of the metabolite signal corresponding to the peaks. A relevant portion of a reference chromatogram, for example, can be split into a number of time increments. Query chromatograms can be generated for each portion of a chromatogram that includes data points that contain at least one m/z signal feature. For example, Sample 1 becomes the reference chromatogram. Sample 2 can be shifted to generate multiple query chromatograms. For example, Sample 2 can be shifted in multiple time increments (e.g., 0.1 minute increments) over a period of RT shifts—for example, in this example embodiment, a shift range of +/−10 minutes, although any appropriate amount of time is contemplated. One or more query chromatograms can be generated by transforming Sample 2, which can be transformed by shifting its RT values by each time increment to cover the +/−10 minutes. The transformation can then be assessed in how well it aligns with the reference chromatogram (e.g., Sample 1). For example, the method includes implementing the 0.1 min shift, and then taking the intersection of points between the shifted data (query chromatogram)and the non-shifted data (reference chromatogram). The data points without a partner are summed to get a scoring function value. In other words, in some embodiments the average difference between the reference chromatogram and each query chromatogram generates a score. The best fit (e.g., the amount of RT shift experienced by Sample 2) is determined by minimizing the score. In other words, the best fit will have the lowest score. Once the best fit is determined, Sample 2 can be shifted in accordance with the RT value of the best fit, therefore aligning the peaks within Samples 1 and 2.

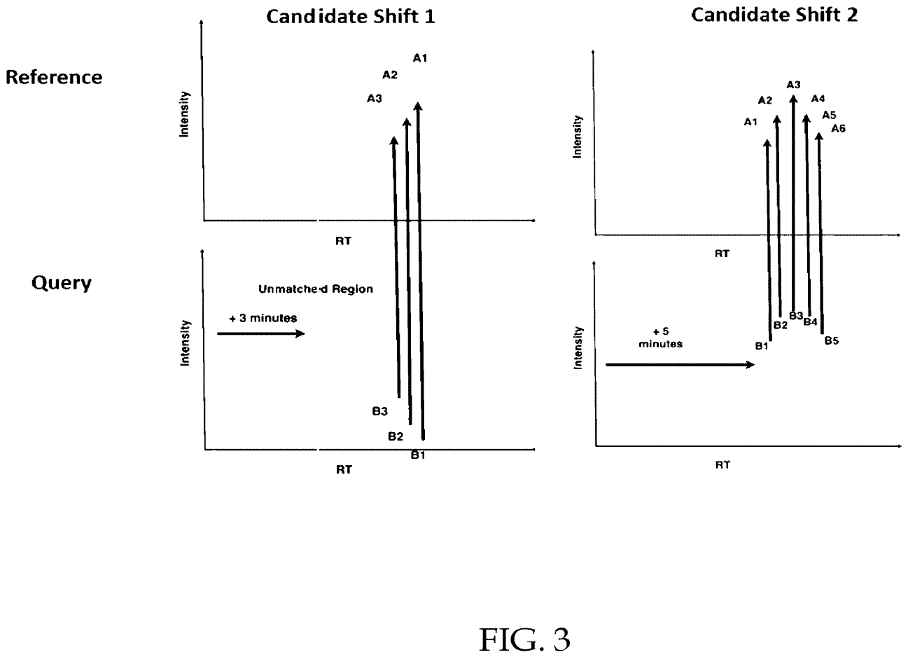

FIG. 3 illustrates such query chromatogram RT shifts. In the example embodiment shown, Candidate Shift 1 shows an example reference chromatogram (top) that shows retention time (RT) vs. intensity. Data points A1, A2, and A3 belong to a peak within the dataset that corresponds with a metabolite signature. The peak appears, however, in conjunction with a certain amount of noise. While the signals associated with the compound can be consistent with a specific statistical (e.g., Gaussian) distribution, the specific peaks can not be concentrated enough to be detectable amidst the noise (which does not follow any particular distribution).

In some embodiments, the drift of an m/z signal feature can be determined on a metabolite-by-metabolite basis by identifying the shift range to be tested—e.g., determining the time increments that equally span both before and after an m/z signal feature. In some embodiments, the m/z signal feature can be identified as a metabolite.

In some embodiments, for each time increment within the shift range, a query chromatogram can be generated by shifting the data points by some time increment within the shift range. In some embodiments, the query chromatogram can generated based on an m/z signal feature having an intensity over a threshold value. A threshold can be inserted, for example, so that only a peak in intensity above a certain threshold is flagged for data processing (e.g., gets rid of noise). This prevents the noise from getting scored in the scoring function.

For example, in the embodiment shown, the query chromatogram has been shifted by +3 minutes. Some of the data points of the peak within the query chromatogram overlap with the peak of the reference chromatogram—in this example, data points B1, B2, and B3. That set of data points can be determined as a first subset of data points that intersect with the data points between the reference chromatogram and the query chromatogram: B1 overlaps with A1, B2 overlaps with A2, and B3 overlaps with A3. A second subset of data points can correspond to an unmatched region—e.g., the data points that belong to the second peak (e.g., the m/z signal feature within the query chromatogram) that lies outside the intersection of data points. A scoring value can be determined based on a sum of the unmatched region.

This process can be repeated for another time increment. Candidate Shift 2 shows an example reference chromatogram (top) that shows retention time (RT) vs. intensity. Data points A1, A2, A3, A4, A5, and A6 belong to a peak within the dataset that corresponds with the metabolite signature. The query chromatogram has been shifted this time to +5 minutes. In this case, more data points intersect between the query and the reference chromatograms. For example, B1 overlaps with A1, B2 overlaps with A2, B3 overlaps with A3, B4 overlaps with A4, and B5 overlaps with A5. The unmatched region in this case has become negligible—the alignment matches almost perfectly. In this case, the scoring value would be 0 or close to 0 based on the disappearance of the unmatched region.

In some embodiments, a scoring function to get an alignment for each metabolite can be generated based on the scoring values at each time increment. The scoring function can be based on a probability of the drift per time shift (e.g., +/−some time t from the non-drifted signal in the reference chromatogram). For example, for a shift range of 10 minutes, a query chromatogram can be generated as the method integrates through the entire shift range (e.g., from −10.0 min, −9.9 min . . . +9.9 min, +10.0 min in 0.1 minute increments) to get the scoring function.

Additionally and/or alternatively, in some embodiments a metric of similarity can be determined based on the scoring function, where the metric of similarity measures a probability that an optimal shift that minimizes an average difference in the data points between the reference chromatogram and the query chromatogram is a drift of the m/z signal feature. Metrics of similarity are quantitative measures used to assess the degree of resemblance or alignment between two sets of data. These metrics are widely used in various fields, including data analysis, machine learning, pattern recognition, and bioinformatics, to compare and evaluate the similarity between data points, sequences, or structures. Metrics of similarity can take various forms, such as distance measures, correlation coefficients, or probabilistic scores, and are designed to capture different embodiments of similarity depending on the context and application. Non-limiting examples of metrics of similarity include: Euclidean Distance: A measure of the straight-line distance between two points in a multi-dimensional space. It is commonly used in clustering and classification algorithms; Cosine Similarity: A measure of the cosine of the angle between two vectors in a multi-dimensional space. It is often used in text analysis and information retrieval to compare the similarity of documents; Pearson Correlation Coefficient: A measure of the linear correlation between two variables. It ranges from −1 to 1, with values closer to 1 indicating a strong positive correlation and values closer to −1 indicating a strong negative correlation; Jaccard Index: A measure of the similarity between two sets, defined as the size of the intersection divided by the size of the union of the sets. It is commonly used in clustering and classification tasks; Dynamic Time Warping (DTW): A measure of similarity between two temporal sequences that can vary in speed. It is often used in speech recognition and time series analysis; or any combination thereof.

In the context of the present disclosure, the metric of similarity can be a quantitative measure used to evaluate the alignment of data points between a reference extracted ion chromatogram (EIC) and a query EIC in chromatography-mass spectrometry (chromatography-MS) data. The metric of similarity can be designed to capture the degree of alignment between the reference and query EICs after applying a shift to the query EIC, with the goal of correcting drift in retention times of compound signals.

A metric of similarity in this invention can be used to determine an optimal shift that minimizes the average difference in the data points between the reference chromatogram and the query chromatogram. This optimal shift represents the actual drift of the mass-to-charge (m/z) signal feature, ensuring accurate alignment of the chromatograms. A metric of similarity can also be used to distinguish between actual drift of the m/z signal feature and other factors such as noise, artifacts, or the presence of isomers. By comparing subsets of files high in any pair of two peaks and identifying symmetrical features within the scoring function, the metric of similarity can ensure that the identified shift accurately represents the drift and not other confounding factors.

A metric of similarity can be calculated using various methods, including but not limited to: sum of matched or unmatched data points, weighted sum, using statistical measures, using machine learning algorithms, or any combination thereof. The metric can be based on the sum of data points that overlap or, alternatively, do not align between the reference EIC and the query EIC after the shift. Minimizing the sum of data points that do not align between the reference EIC and the query EIC after the shift indicates the least amount of mismatch and the best alignment, whereas maximizing the sum of data points that overlap between the reference EIC and the query EIC after the shift indicates the least amount of mismatch and the best alignment.

When a metric of similarity is based on weighted sums, data points closer to the peak of the chromatogram can be given higher weights, as their alignment is more significant to the accurate identification of compounds. The weighted sum of these points can be minimized to determine the optimal shift. When a metric of similarity is based on statistical measures such as the mean, median, or standard deviation of the second subset of data points, minimizing these values can indicate a tighter clustering of mismatched data points around a central value, suggesting a more consistent drift that can be corrected. Features such as the shape, spread, and intensity distribution of the second subset can be inputs to a machine learning model that outputs a score representing the degree of misalignment. The model can be trained to minimize this score for optimal alignment.

In some embodiments, a method of the instant disclosure can comprise using a metric of similarity based on the sum of unmatched data points that do not align between the reference EIC and the query EIC after the shift. Minimizing this sum indicates the least amount of mismatch and the best alignment.

In order to determine the correct alignment, the time increment that corresponds to a minimization of the scoring function (e.g., the smallest scoring value) provides the best alignment for the drift of the second peak in retention time (e.g., the correct drift). The query chromatogram can then be corrected for drift in RT by shifting the query chromatogram by the time increment associated with the minimized scoring value. In the example shown, the correct drift would be identified as +5 minutes. Therefore, the query chromatogram can be shifted by +5 minutes to align with the reference chromatogram.

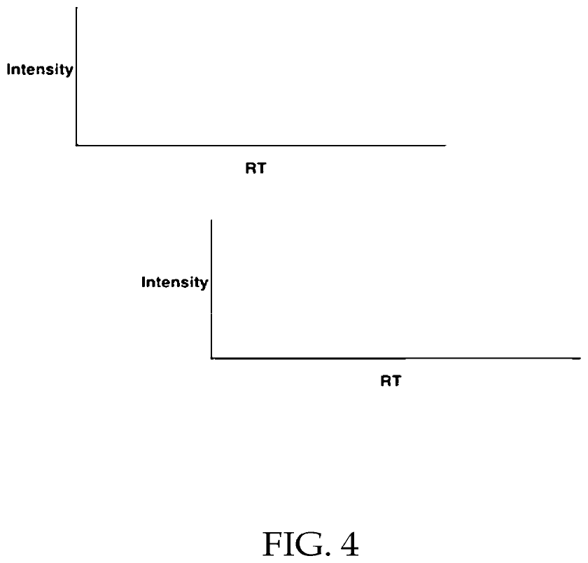

FIG. 4 illustrates an exemplary isomer feature in the mass spectrometry dataset, in accordance with example embodiments. The example chromatogram shows retention time (RT) vs. intensity. In this case, the signal shows two peaks: a larger peak and a smaller peak. However, upon shifting the query chromatograms, the peaks are merely swapped. This situation arises when a metabolite has an isomer.

In some embodiments, for example, the compound of interest can be a metabolite or other type of organic compound with an isomer. An isomer refers to compounds that have the same molecular formula but are structurally different. Isomers can show up within chromatograms as a secondary peak that's offset from its counterpart metabolite. A true signal for the specific compound can therefore be accompanied by a valid signal of a naturally-occurring isomer that is lower in abundance and whose signal is offset from the true signal by some RT difference. Thus, when m/z-signal intensities from multiple samples are combined into a single, merged file of m/z signal-intensities, the probability of finding isomers offset within a retention time window increases significantly.

The correct alignment for RT drift is determined by minimizing the unmatched region(s) within the query chromatograms. A global best fit technique to all m/z signals in the extracted ion chromatogram is not employed because of the potential presence of isomers. A best fit for an isomer, for example, would show up as large unmatched regions, and such unmatched regions are symmetrical. For example, shifting the lower chromatogram shows how the two peaks each have large unmatched regions. In some embodiments, a true alignment is break symmetry to validate the RT shift. In some embodiments, if a symmetry exists, an RT drift correction is not implemented.

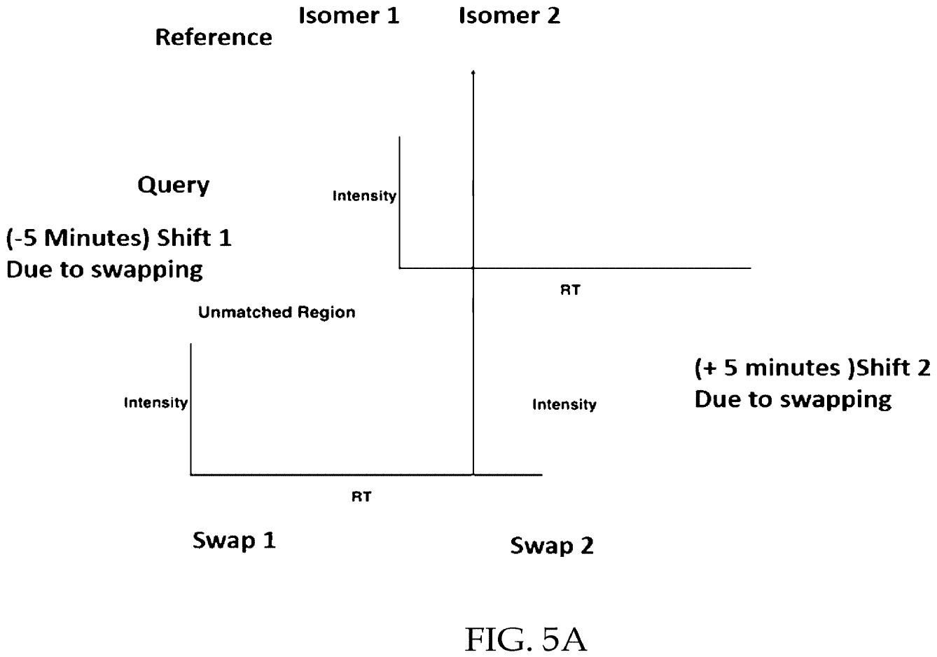

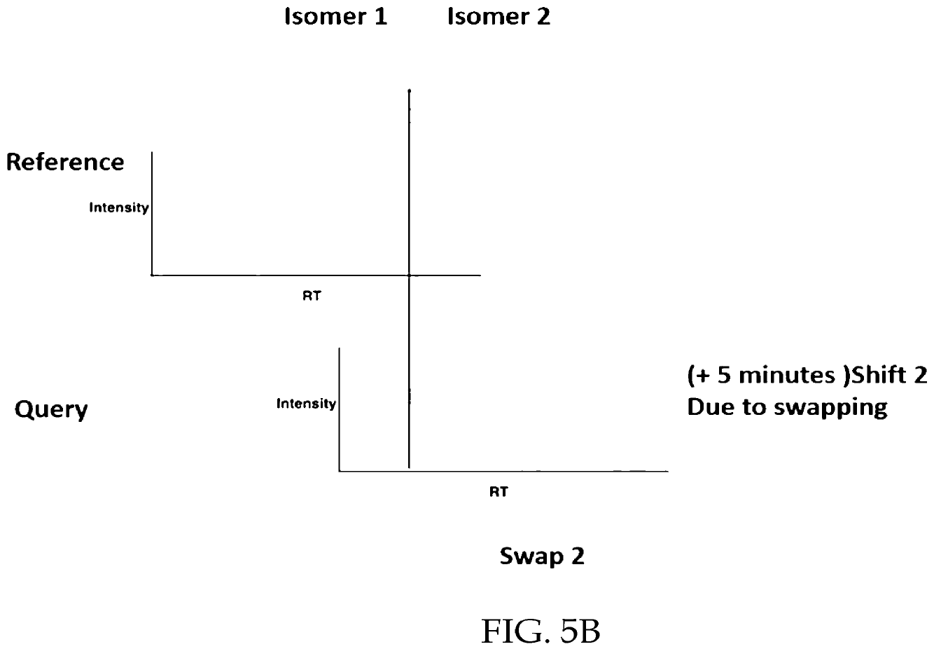

FIG. 5A illustrates an exemplary isomer swap in the mass spectrometry dataset, in accordance with example embodiments. In the example embodiment shown, an example reference chromatogram (top) shows retention time (RT) vs. intensity. The peak on the left corresponds to a first isomer of a metabolite signature, and the peak on the right corresponds to a second isomer of a metabolite signature. Shifting the query chromatogram by −5 minutes in this instance, however, provides a great fit between isomer 1 in the reference chromatogram and isomer 2 in the query chromatogram, but a large unmatched region remains from isomer 1 in the query chromatogram. Therefore, a global best fit approach would only swap isomers.

FIG. 5B shows the same reference chromatogram, but now the query chromatogram has been shifted +5 minutes. The same best fit, but large unmatched region, persists for the m/z signals. Shifting the query chromatogram by +5 minutes provides a great fit between isomer 2 in the reference chromatogram and isomer 1 in the query chromatogram, but a large unmatched region remains from isomer 2 in the query chromatogram. The isomers have merely swapped. Moreover, the unmatched regions are symmetrical in RT shift.

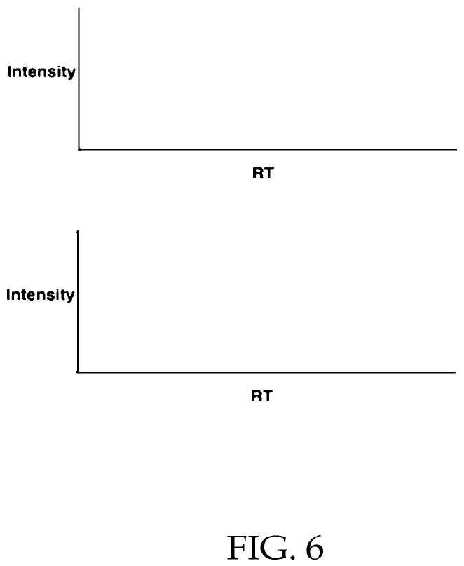

FIG. 6 illustrates a correct alignment in the mass spectrometry dataset, in accordance with example embodiments. In order to generate the correct alignment for isomers, the area within an unmatched region is summed within each query chromatogram. The top N percent of signals in taken in each chromatogram, and scans which have symmetrical intensities are removed. For example, a pair of scoring function values that correspond to symmetrical features can be determined within a scoring function. The method further determines that the pair of scoring function values indicate a poor fit in both directions of the plurality of time increments, centered around an m/z signal. This symmetry and poor fit in both RT shift directions are conditions that determine that the m/z signal feature corresponds to an isomer rather than a drift in retention time.

In other words, if a peak belongs to an isomer rather than drift, once the query chromatogram is shifted right, the fit can be good (e.g., all points have a partner in the non-shifted data of the reference chromatogram), but there remains an appreciable signal in the unmatched region because it's a different isomer. That signal with the unmatched region will be penalized in the scoring function, as the scoring function seeks to minimize the unmatched region. Also, if the query chromatogram is shifted to the left, the same thing happens—all the points in one isomer have a partner, and all of the points in another isomer are unmatched, and the algorithm penalizes this shift. Poor fits in both directions (e.g., poor fits on both the left and the right—the same shift) are a signature of isomer swapping.

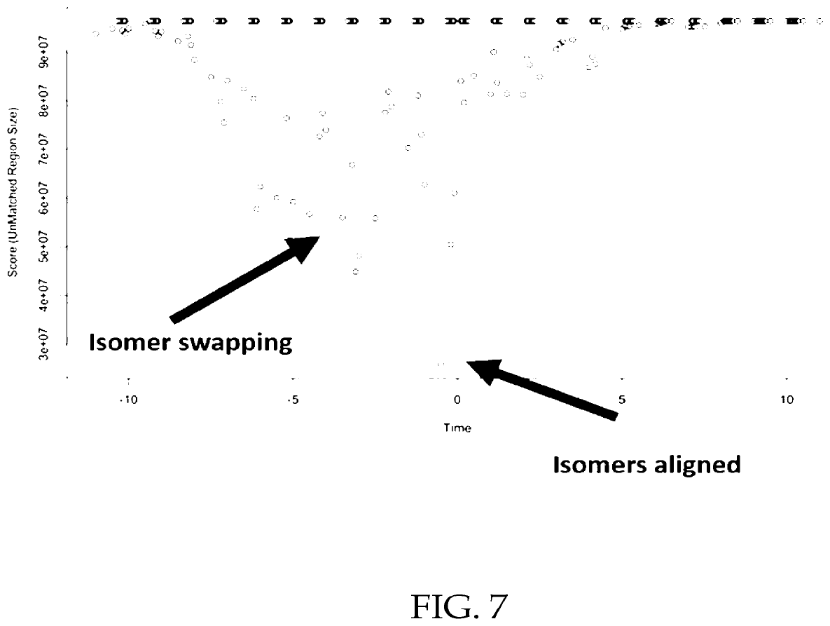

FIG. 7 illustrates exemplary scoring function values that show when isomers are properly aligned, in accordance with example embodiments. The scoring function is based on the unmatched region size in each reference chromatogram. Isomer swapping (when multiple isomers exist in the dataset) often result in a jumble of close fits in both the left and right directions of the shift—especially when some samples only have the middle isomer. In this case, the jumble of close fits within FIG. 7 point to one or more isomers in the data, which are aligned when the unmatched region size is minimized. Here, at around RT of −0.7 minute shift.

In some embodiments, a t-test on the average signal similarity in the left and right direction indicate isomer presence if the p-value is >0.01. If so, the shift is excluded.

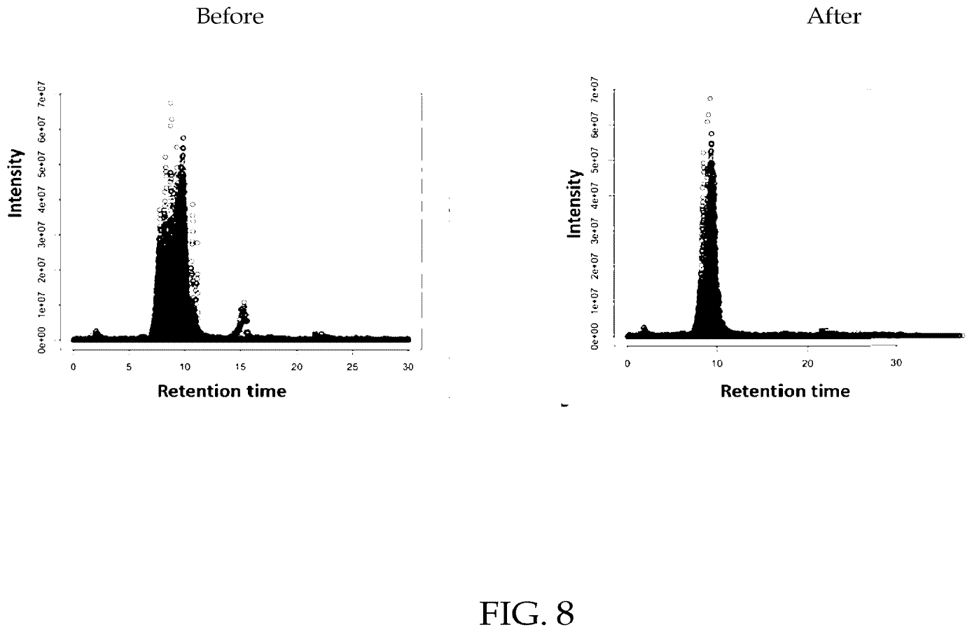

FIG. 8 illustrates an exemplary mass spectrometry dataset associated with a certain compound before and after retention time correction has been applied, in accordance with example embodiments. The chromatogram on the left shows an unprocessed chromatogram including two peaks corresponding to a citrulline detection—a left, main peak at around 9 RT and a smaller, right peak at around 15 RT. After applying a shift in accordance with a minimized scoring function, the corrected chromatogram on the right shows that the entire citrulline feature is concentrated in the one main peak at around 9 RT.

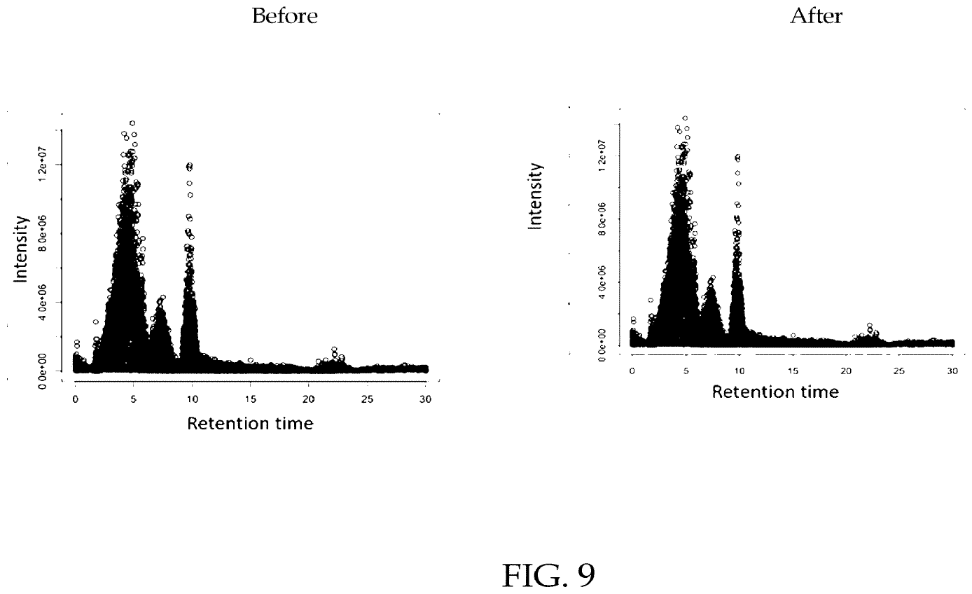

Applying the same methodology, FIG. 9 illustrates an exemplary mass spectrometry dataset associated with isomer preservation before and after retention time correction has been applied. The chromatogram on the left shows an unprocessed chromatogram including three peaks corresponding to isomer detection—a left peak at around 4 RT, a middle peak at around 7 RT, and a third peak at around 10 RT. After minimizing the scoring function, the corrected chromatogram on the right shows that the three peaks corresponding to isomers are preserved in the signal (e.g., the peaks have not been incorrectly merged into a single peak).

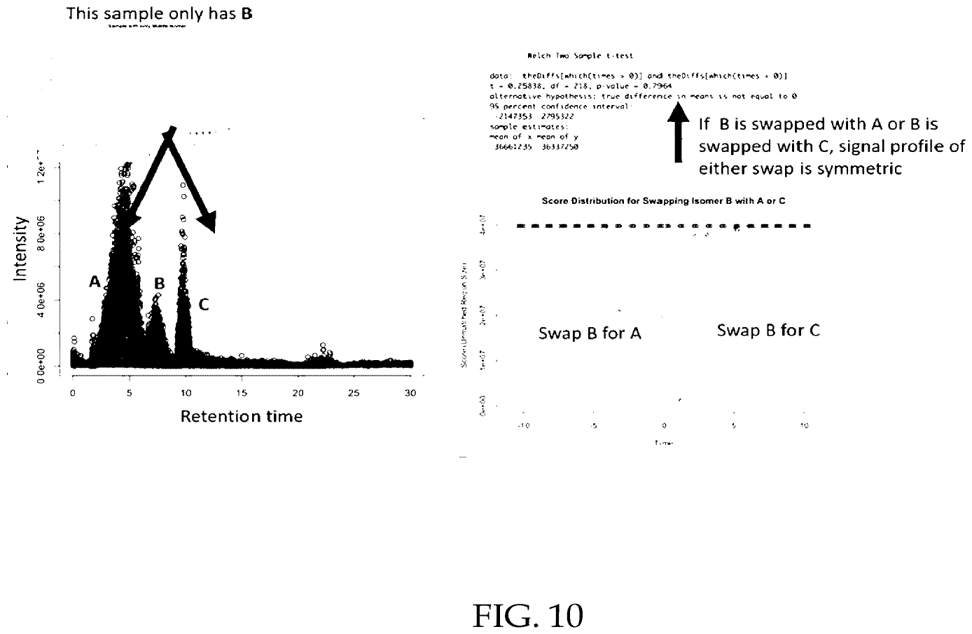

FIG. 10 illustrates a further exemplary example to correct for isomer swapping, in accordance with example embodiments. The chromatogram shows three peaks corresponding to isomer detection—peak A at around 4 minutes retention time, peak B at around 7 minutes retention time, and peak C at around 10. minutes retention time. If peak B is swapped with peak A, or if peak B is swapped with C, the signal profile in the scoring function is symmetric in the score distribution. This indicates that peak C is an isomer and is excluded from drift calculation.

In some embodiments, the process is parallelizable—query extracted ion chromatograms for each mass can be generated at the same time using different processors. For example, query chromatograms can be generated for each m/z signal feature within the portion of the reference chromatogram, where the time increment that corresponds to the retention time drift of isomer associated with each m/z signal feature is determined concurrently on different processors.

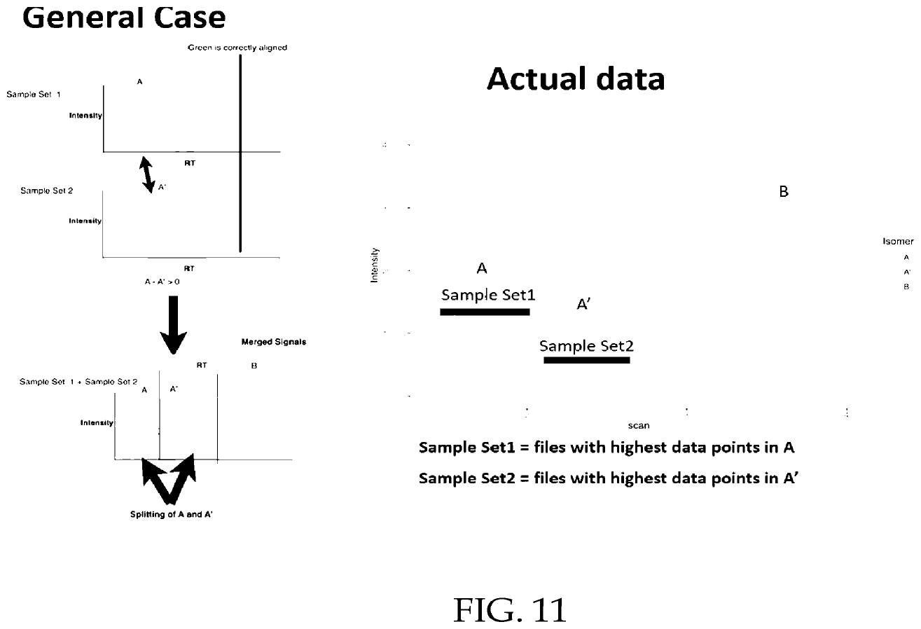

FIG. 11 illustrates an exemplary situation in which an overall correct alignment can be determined for the m/z signal features associated with an extracted ion chromatogram between a query sample and a reference sample, and yet this drift only partially captures the total drift. This occurs when separate isomers present in the same extracted ion chromatogram have difference drift profiles. For example, isomer B can drift 5 minutes, while isomer A can drift only two, or not at all in some samples (or vice versa). Therefore, FIG. 11. illustrates how when the merged extracted ion chromatogram of an m/z signal is created, an isomer can manifest as split peaks A and A′. FIG. 11 shows how a subset of the highest files with data in isomer A can be created (Subset 1) for comparison with the subset of highest files with data in isomer A′ (Subset 2).

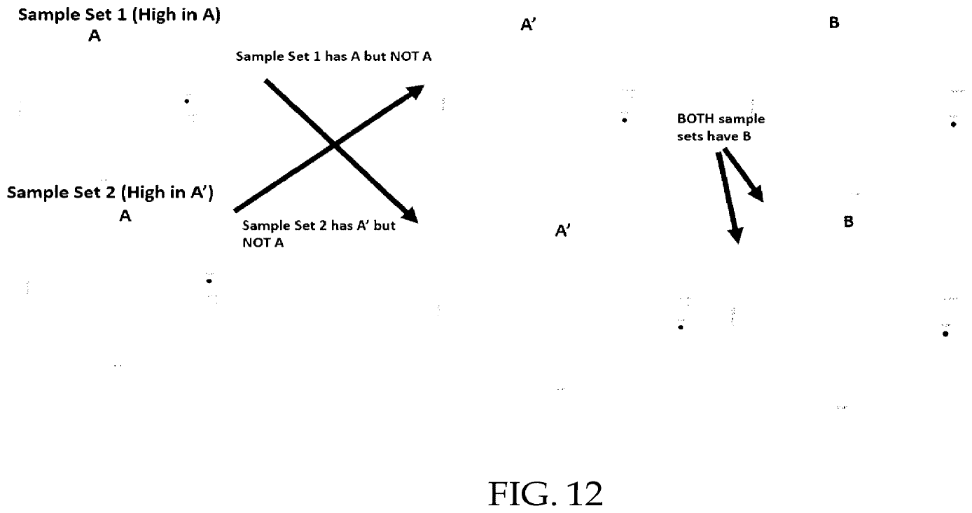

FIG. 12 illustrates how the signal distribution for each peak in Subset 1 vs Subset 2 can be used to determine if split peaks should be merged, or if they are recognized as distinct isomers. This is because, if a split peak is artifactual (i.e. A′), then signals for A and A′ should be mutually exclusive for Subset 1 and Subset 2. In other words, if a sample has data for A, then it should not have data for A′. FIG. 12 also shows how peaks that are likely to be isomers, as opposed to split peaks (i.e. isomer B) should be present in any set of samples regardless of the presence of other isomers.

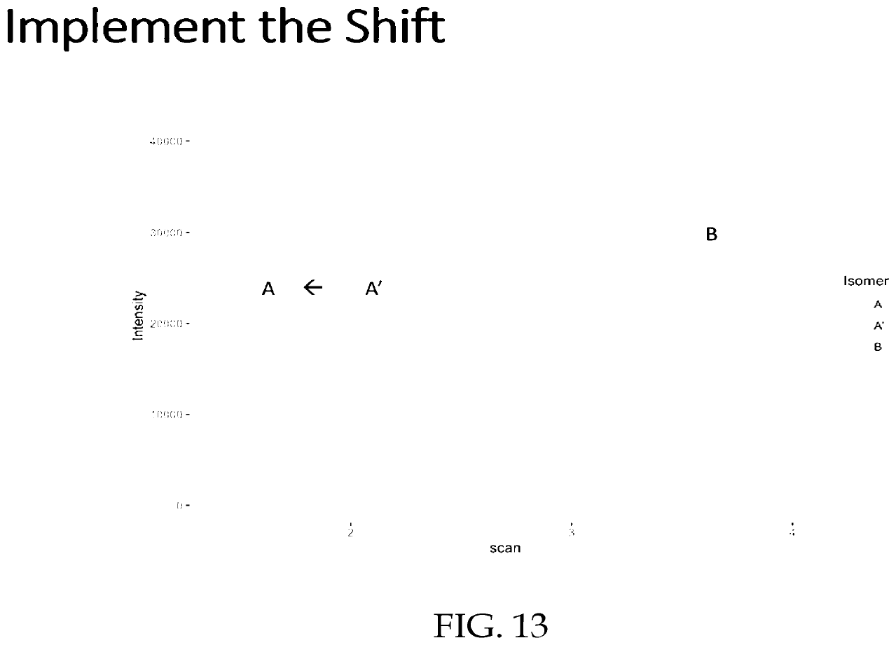

FIG. 13 illustrates how A and A′ can be merged into a single isomer. This requires implementing a shift to all data in A′ equivalent to the median difference in the retention time of A′ vs A to all files with data in A′. The peak with less signal is always merged into that with more. If the pair of peaks is properly assigned as a single isomer after this shift, this shift should not increase any mismatches in signal. Therefore, the metric of similarity between files in Subset 1 and Subset 2 should increase following the successful merging of an artifact with its parent signal.

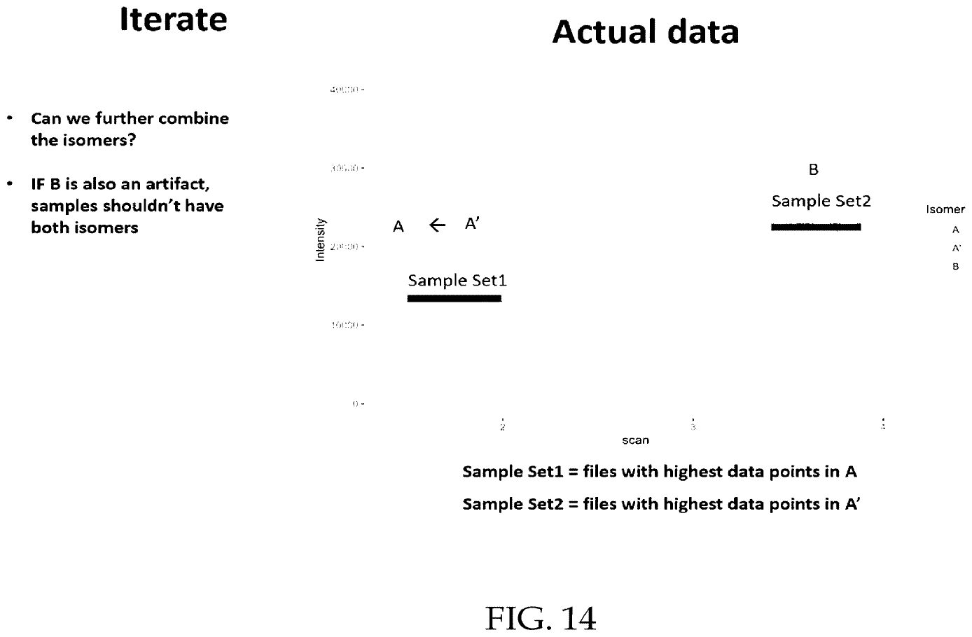

FIG. 14 illustrates how each peak can be assessed in an iterative fashion to determine if it is an artifact of drift from other peaks, or in fact a unique isomer. The methodology of taking signals from the highest set samples in each peak is repeated. If the signals should be shifted into one another because one is split from the other, then a peak with signal in Subset 1 should not have signal in Subset 2, and vice versa.

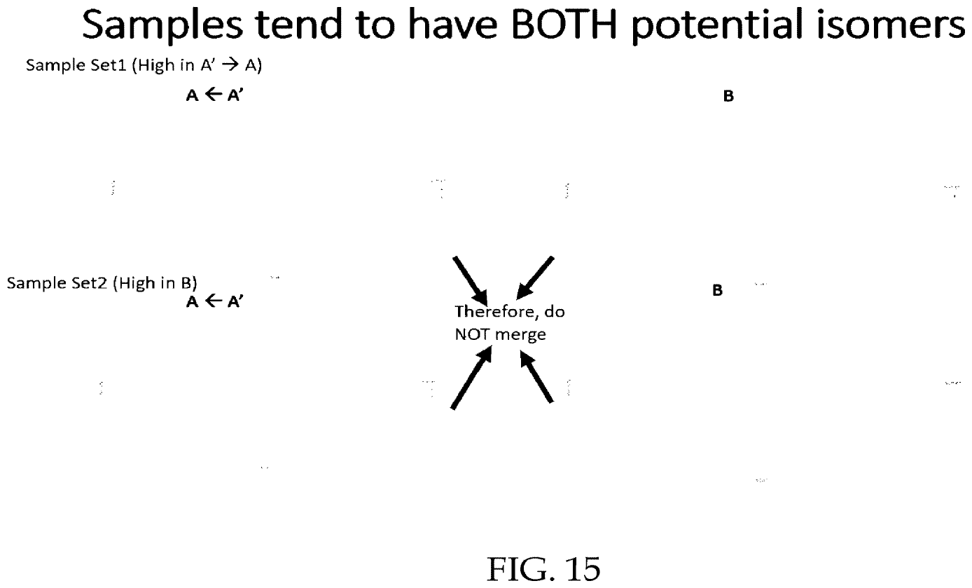

FIG. 15 illustrates how two peaks can be distinguished as isomers as opposed to drift. In this case, samples (Subset 1) high in the first peak also have signal in the second peak. Additionally, samples (Subset 2) high in the second peak also have signal in the first peak. Therefore, if these two peaks were to be merged, signal from one peak would push out that of the other peak. This would cause an increase in the mismatch in the signals of Subset 1 and Subset 2, thereby causing a worse similarity metric.

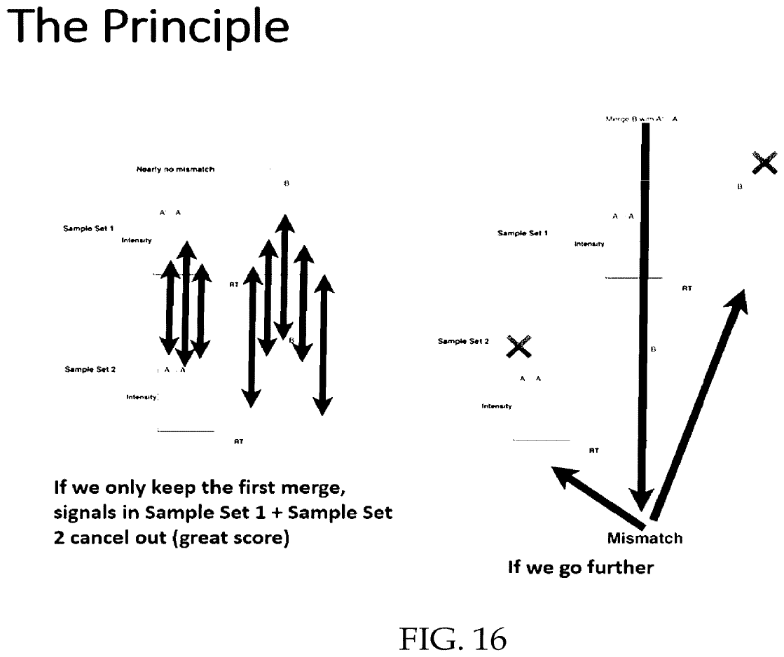

FIG. 16 illustrates how the similarity metric between Subset 1 and Subset 2 can assess the validity of merging two peaks that could be isomers or drift. When two peaks are isomers and no shift is implemented to merge them, the metric of similarity is at its best. However, when a pair of isomer peaks are improperly merged, the metric of similarity between Subset 1 and Subset 2 indicates a worse fit because the level of signal mismatch is increased.

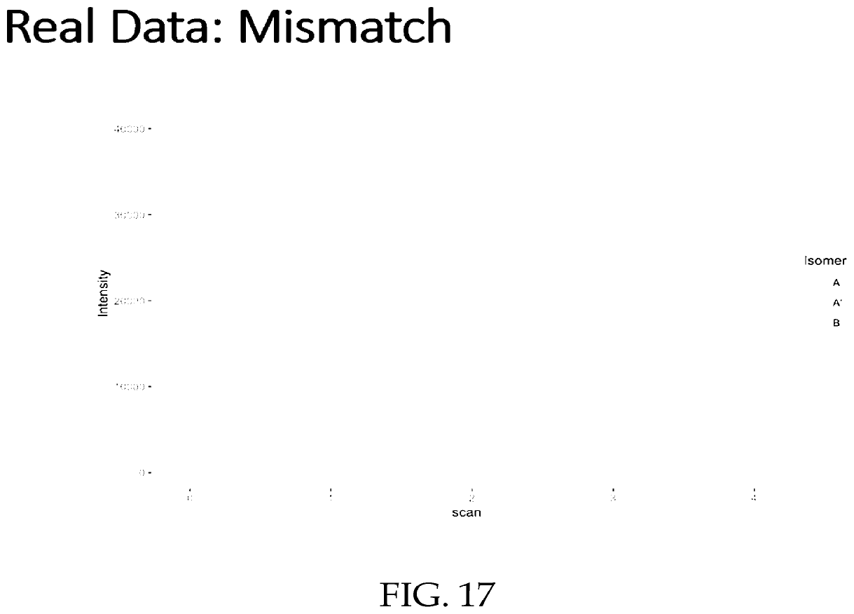

FIG. 17 illustrates the consequence of improperly merging peaks that are isomers on actual data. As predicted, the signal of one isomer pushes out that of the other, causing a dramatic increase in the level of signal mismatch between Subset 1 and Subset 2. Therefore, drift in retention times can be calculated on a metabolite by metabolite basis. The techniques described herein are a local, unique extracted ion chromatogram (EIC)-based alignment instead of a global alignment. In some embodiments, for each plausible shift (e.g., increments of 0.1 minutes), sparsity can be achieved by only taking scans in common to each sample after the shift. This often reduces to only 5-10 scans (for a single peak). For each of the scans with signal between the reference chromatogram and the query chromatogram after the shift, the average difference can be determined in their intensities (i.e. has the shift aligned the signals). The optimal shift will minimize the average difference in the signals between the reference and query chromatograms (e.g., through a metric of similarity). This process can extract ion chromatograms of each m/z value independently, removing the need for a global or semi-global warping algorithm to correct for global warping effects. This process in robust to isomer swapping, rapid and parallelizable, and relies on minimizing the mismatch between signals rather than maximining the math between signals.

### (b) Mass Spectrometry

MS is a powerful analytical tool that can be combined with separation methods such as chromatography (chromatography-MS) for effective detection and quantitation of various compounds in a sample. Chromatography-MS comprises a first separation of components of a sample by chromatography where compounds with different properties separate and are collected at different times. The time point at which a certain fraction of a compound elutes from the column is called the retention time (RT). The resulting fractions are then inserted online into the mass spectrometer. Here the second separation takes place. By ionizing the compounds and accelerating them to fly through a spectrometer, the compounds are separated by their mass-to-charge (m/z) ratio (also referred to herein as “mass” for the sake of simplicity). Accordingly, a plurality of m/z signal intensities can be captured by a mass spectrometer in an output file, while intensity data records the abundance of a species of a given m/z relative to retention time. The measured data can then be depicted in a total ion chromatogram (TIC) 3D image comprising three axes. One axis depicts the RT, the second represents the m/z value, and the third axis represents the intensity or quantity of a peptide. The combined data of RT, m/z value, and intensity for each sample can be obtained as a chromatography-MS data file.

Methods of the instant disclosure comprise overcoming drift by focusing the analysis on a portion of a MS chromatogram bearing the same m/z value. In a typical analysis, a chromatography-MS data file can comprise up to 20,000 or more m/z values that represent the masses of plausible compounds. The retention time profile of each of these m/z values can be drawn from a TIC and can be depicted in an extracted ion chromatogram file (EIC file or EIC for short). Accordingly, an EIC is a chromatogram for a particular m/z value, such as for ion 55, 57, 83, or 105, each comprising a characteristic retention time profile. The retention time profile displays retention time, which is indicative of the time it takes for a compound to travel through the chromatographic and MS systems, and intensity, which correlates to the abundance of the ions.

This method can be particularly useful in the context of isomers, which are compounds with the same molecular formula but different structural arrangements. Despite having the same m/z value due to their identical molecular weights, isomers often exhibit different retention times in the chromatographic system due to their distinct physical and chemical properties. This allows the separation and identification of isomers within a sample. Therefore, a mass spectrometry EIC of a specific m/z value can provide a comprehensive profile that includes not only the intensity and retention time of a compound but also allows the differentiation and analysis of its isomers. For instance, it is possible to discern detailed information about compounds from the retention time profile in an EIC file, including the presence or absence of compound isomers that share this particular m/z value, the number of compound isomers, and their relative abundance. FIG. 8 depicts hypothetical retention time profiles from EICs of a specific m/z value. This figure illustrates various retention time profile variants at this m/z value that could be present in various samples, each comprising a different number of isomers and/or intensity levels for each isomer identified by the Gaussian distribution of data values around various retention times.

As previously discussed, a major challenge in utilizing chromatography-MS techniques for untargeted compound detection and quantification, such as in untargeted metabolomics, is the need to adjust for retention time drift. Existing approaches try to synchronize samples in the retention time domain using either all data points or extensive segments of the signal. However, these segments might not always act predictably, making such alignment methods susceptible to statistical biases and inaccuracies. This is particularly problematic for metabolites with isomer profiles that are difficult to differentiate. The issue arises because the characteristics of each species are often subtle and exhibit variability across samples, typically presenting as low signal-to-noise ratios. In individual files, the signal might be too weak to distinguish even a single isomer. Combining samples to form a composite extracted ion chromatogram could enhance or amplify the detectability of a compound's signal. However, retention time of isomers in an retention time profile of an EIC can vary from sample to sample due to inevitable drift, leading to blurring of isomer signals. Conversely, in the absence of drift, there's a risk of incorrectly interchanging isomers. FIG. 8 depicts pooled retention time profile of EIC files of a particular m/z value, derived from real data, showcasing the difficulty in interpreting such complex information.

Methods of the instant disclosure comprise independently correcting retention time drift in each of a plurality of EICs of compounds bearing the same m/z value before combining data values for each compound and/or a compound's isomer(s) to amplify the isomers' signals. Since mass and retention time are analyzed separately, this approach has enabled the development of retention time correction algorithms that independently adjust the signals for each m/z value (See Sections I(a) and (c) herein below).

In some embodiments, the methods comprise obtaining or having obtained one or more data files from a chromatography-mass spectrometry machine that has analyzed a sample of unknown compounds. The data in the data file can include a retention time and a mass-to-charge (m/z) signal intensity for each data point in the data file. As methods of the instant disclosure comprise independently correcting drift in a plurality EICs of compounds bearing the same m/z value, in some embodiments, a method of the instant disclosure can further comprise identifying or having identified an m/z value most likely to belong to a compound for which an EIC can be extracted. In some embodiments, the m/z value most likely to belong to a compound is identified using methods described in International Application No. PCT/US2022/028150, the disclosure of which is incorporated herein in its entirety.

The methods can be used to correct drift in hundreds, to thousands, to hundreds of thousands of EICs for a specific m/z value extracted from a plurality TICs. The plurality of chromatograms can originate from a diverse range of samples, offering a broad scope for analysis and comparison. These chromatograms can be derived from a single sample, providing a detailed, focused examination of its components. Alternatively, chromatograms can be obtained from multiple samples collected independently, allowing for a comparative analysis across a wider range of variables. This versatility is particularly useful in experiments involving various treatments or conditions. For instance, samples from different treatment groups in a study can be analyzed to compare and contrast the effects of these treatments at a molecular level. Similarly, samples under different experimental conditions can provide insights into how these conditions influence the chemical composition of the samples.

Methods of the instant disclosure can be used to overcome drift in retention times in chromatography-MS runs for untargeted analyses of any compound, including chemical, pharmaceutical, biochemical, and metabolomic compounds. Non-limiting examples of chemical, biochemical, and metabolomic compounds include biochemical compounds such as amino acids, peptides and proteins, nucleotides and nucleosides, DNA and RNA fragments, lipids (fatty acids, triglycerides, phospholipids, steroids), carbohydrates (monosaccharides, disaccharides, polysaccharides), vitamins, hormones, and enzymes; metabolomic compounds such as metabolic intermediates (glycolysis intermediates, Krebs cycle intermediates), neurotransmitters, plant metabolites (alkaloids, terpenes, flavonoids), bacterial and fungal metabolites, endogenous metabolites (bile acids, urea cycle intermediates), and xenobiotics (drugs, toxins); environmental contaminants such as pesticides and herbicides, polycyclic aromatic hydrocarbons (PAHs), persistent organic pollutants (POPs), and heavy metals and metalloids (in their organic forms); pharmaceuticals such as therapeutic drugs, drug metabolites, antibiotics; polymeric materials such as polymers and copolymers, additives and plasticizers, and oligomers; isotopically labeled compounds such as stable isotope labeled metabolites, deuterated compounds; industrial chemicals such as dyes and pigments, surfactants and detergents, and explosives; food and beverage analysis such as food additives, flavor compounds, contaminants; forensic analysis such as illicit drugs, explosive residues, and trace evidence compounds; and geological and cosmochemical analysis such as elemental isotopes, and organic molecules in extraterrestrial samples.

In some embodiments, methods of the instant disclosure can be used to overcome drift in retention times of chromatography-MS runs for analyses of metabolites. While specific types of compounds (e.g., metabolites such as fructose and galactose) can be discussed herein, such discussion of specific embodiments is for illustrative purposes and should not be interpreted as limiting the present disclosure to the specific embodiments being illustrated and discussed.

There are multiple categories of chromatography and MS, wherein each combination of chromatography and MS methods can cater to different analytical needs, depending on the complexity of the sample, the required sensitivity, resolution, and speed of analysis. The choice of technique is often determined by the specific application and the nature of the compounds being analyzed.

Non-limiting examples of major categories of chromatographic techniques that can be coupled with MS include Liquid Chromatography-Mass Spectrometry (LC-MS), Gas Chromatography-Mass Spectrometry (GC-MS), lon Chromatography-Mass Spectrometry (IC-MS), Supercritical Fluid Chromatography-Mass Spectrometry (SFC-MS), Capillary Electrophoresis-Mass Spectrometry (CE-MS). Liquid chromatography methods can include High-Performance Liquid Chromatography (HPLC)-the most common form, utilizing high pressure to pass the sample through a column filled with stationary phase; Ultra-Performance Liquid Chromatography (UPLC)—similar to HPLC but uses smaller particle sizes in the column for higher resolution and faster analysis; Ion Exchange Chromatography—separates ions based on their affinity to an ion exchanger in the column; Size Exclusion Chromatography (SEC)—separates molecules based on size, using a column with pores of a specific size; Normal Phase Chromatography—uses a polar stationary phase and a non-polar mobile phase; Reverse Phase Chromatography—uses a non-polar stationary phase and a polar mobile phase, opposite to normal phase; Chiral Chromatography—separates enantiomers based on their interaction with a chiral stationary phase; Affinity Chromatography—uses a stationary phase made of materials that specifically bind to the analyte of interest. Gas chromatography methods include Capillary Gas Chromatography—uses very narrow capillary tubes with a liquid stationary phase; Packed Column Gas Chromatography—utilizes columns packed with solid stationary phase or solid support coated with liquid stationary phase; Gas-Solid Chromatography (GSC)—involves a solid stationary phase and is used primarily for separating gases or volatile compounds that don't interact with liquid stationary phases. lon chromatography is typically used for the separation of ions and polar molecules. Supercritical Fluid Chromatography-Mass Spectrometry (SFC-MS) uses a supercritical fluid (like CO2) as the mobile phase, combining aspects of both GC and LC. It's particularly effective for analyzing compounds that are difficult to separate by traditional LC, such as chiral compounds. Capillary Electrophoresis: Although not technically a chromatographic technique, capillary electrophoresis separates ions based on their charge-to-size ratio in an electric field.

Non-limiting examples of MS include Quadrupole Mass Spectrometry (QMS)—uses quadrupole filters for mass analysis, suitable for a broad range of masses; Time-of-Flight Mass Spectrometry (TOF-MS); separates ions by their different flight times; lon Trap Mass Spectrometry—traps ions using electromagnetic fields and then sequentially ejects them for mass analysis; Fourier Transform lon Cyclotron Resonance (FT-ICR)—offers very high resolution and accuracy, using a magnetic field to trap ions; Orbitrap Mass Spectrometry uses an electrostatic field to trap ions in an orbital motion around a central electrode; Triple Quadrupole Mass Spectrometry (QqQ) which incorporates three quadrupoles in series; commonly used for quantification due to its high sensitivity and specificity; Tandem Mass Spectrometry (MS/MS) which involves multiple stages of mass spectrometry, often with fragmentation of analyte ions between stages; Quadrupole Time-of-Flight Mass Spectrometry (Q-TOF) which combines quadrupole mass filtering with TOF mass analysis for high accuracy and resolution; and Magnetic Sector Mass Spectrometry which uses a magnetic field to deflect ions, with separation based on mass-to-charge ratio.

In some embodiments, methods of the instant disclosure can be used to overcome drift in retention times of LC-MS runs. In some embodiments, methods of the instant disclosure can be used to overcome drift in retention times of LC-MS runs for analyses of metabolites.

In addition to chromatography, different separation techniques can also be used in conjunction with mass spectrometry. Non-limiting examples of suitable separation techniques other than chromatography include electrophoresis, ion mobility, Field-Flow Fractionation (FFF), Capillary Electrophoresis (CE), Matrix-Assisted Laser Desorption/Ionization (MALDI), Thermal Desorption (TD), Laser Ablation (LA), Desorption Electrospray Ionization (DESI). Electrophoresis separates charged particles under an electric field, effectively used for biomolecules like DNA and proteins. Ion mobility spectrometry, on the other hand, separates ions based on their mobility in a gas phase under an electric field, useful for distinguishing isomers and conformers. FFF techniques separate particles, macromolecules, or colloids based on their size or density in a fluid under various field forces (such as centrifugal, thermal, or electrical fields). Coupling FFF with MS allows for the analysis of large and complex molecules like proteins and polymers. CE is similar to electrophoresis but conducted in capillary tubes. CE is effective for separating ionic species using an electric field. Its coupling with MS provides high resolution and efficiency, particularly useful for analyzing biomolecules like peptides and nucleotides. Although MALDI is more of an ionization technique than a separation technique, it is often mentioned in the context of MS coupling. It's particularly useful for the analysis of large biomolecules like proteins, DNA, and polymers. TD involves heating a sample to release volatile and semi-volatile compounds. When coupled with MS, it allows for the analysis of compounds in air, materials, and environmental samples. LA comprises using a laser to remove material from a solid sample. Coupling LA with MS enables the analysis of solid samples, particularly in fields like geology and material science, allowing for elemental and isotopic analysis. DESI allows for the direct analysis of samples (even from surfaces) under ambient conditions. It's useful for a wide range of applications, including biological tissues and environmental samples.

### (c) Embodiments

One embodiment of the present disclosure encompasses a method for correcting drift in retention times of metabolite signals. The method comprises splitting a portion of a reference chromatogram containing all the signals associated with a single m/z value (i.e. the multiple isomers potentially associated with that m/z value) into a plurality of time increments, where the plurality of time increments includes data points that contain the data for all mass features associated with a single m/z signal. For each time increment of the plurality of time increments, a query chromatogram can be generated for samples that will be aligned to the reference by shifting the data points by a first time increment of the plurality of time increments. Essentially, if the datapoints in a query chromatogram are altered by the amount X via drift (where X is a finite number which lies among the range of plausible shift values), the entire range of shift values can be explored (i.e. +/−10 mins (in increments of 0.1 minutes, or other suitable interval)) such that X can be determined as the optimal shift value using a scoring methodology detailed throughout the course of the described invention. This is done by iteratively shifting the datapoints in a query chromatogram by all possible values (which will necessarily include the optimal value X) so that each shift can be scored. This is possible because the space of possible shifts is finite and easily explorable computationally (i.e., even if the range of shifts is large +/−10 mins, at a resolution of 0.1 minutes, there are only 100 possible shift values to be evaluated in such a scheme). Each possible shift value for a given query can be evaluated by shifting a query chromatogram by the propose shift value (call this Y) and assessing whether a first subset of data points can be created by forming an intersection of the data points between the reference chromatogram and the adjusted query chromatogram. This first subset corresponds to signals in the query chromatogram which are properly aligned to the reference sample, following implementation of the shift. Meanwhile, a second subset of data points can be created by determining the data points that lie outside the intersection of data points; these datapoints represent signal in the query which is not aligned with the reference, even following the application of the possible shift value. A scoring function value can be generated based on a sum of the second subset of data points. A time increment can be determined that corresponds to a drift of the signal feature in retention time based on minimizing the scoring function value. In other words, the optimal shift value to correct drift in a query sample is determined as that which minimizes mismatches with the reference (i.e. when Y (the shift with the best score value)=X (the actual shift), this score is minimized). The query chromatogram is corrected for drift in retention time by shifting the query chromatogram by the time increment so that the mismatch between the reference and the query is minimized.

In some embodiments, the first m/z signal feature can be identified as a metabolite. The plurality of time increments can be determined that equally span both before and after the first m/z signal feature. Each time increment of the plurality of time increments can be incremented through to generate a scoring function, where the scoring function is generated from a plurality of scoring function values at each time increment. The drift of the first m/z signal feature can be determined on a metabolite-by-metabolite basis by identifying a minimum scoring value in the scoring function.

In some embodiments, the scoring function value can correspond to an unmatched region between the reference chromatogram and the query chromatogram, and the drift of the second m/z signal feature in retention time can be determined based on a minimization of the unmatched region.

In some embodiments, a metric of similarity can be determined based on the scoring function, where the metric of similarity measures a probability that an optimal shift that minimizes an average difference in the data points between the reference chromatogram and the query chromatogram is a drift of the first m/z signal feature.

In some embodiments, a pair of scoring function values can be determined that correspond to symmetrical features within a scoring function. The pair of scoring function values can indicate a poor fit in both directions of the plurality of time increments, centered around the first m/z signal. Based on the symmetrical features and poor fit in both directions, the second m/z signal feature can be determined to correspond to an isomer rather than a drift in retention time.

In some embodiments, a metric of similarity can be determined based on the scoring function can to establish the likelihood that any two m/z signal features are distinct isomers as opposed to a single once split by drift.

In some embodiments, the query chromatogram can be generated based on the first m/z signal feature having an intensity over a threshold value.

In some embodiments, query chromatograms can be generated for each m/z signal feature within the portion of the reference chromatogram. The time increment that corresponds to the drift of each m/z signal feature can be determined concurrently on different processors.

Another embodiment of the instant disclosure encompasses a method for correcting drift in retention times of compound signals in chromatography-mass spectrometry data. The method comprises splitting a reference extracted ion chromatogram of a portion of an MS chromatogram selected from a plurality of EICs into a plurality of time increments, generating a query EIC by shifting the data points of the query EIC by a first time increment of the plurality of time increments, determining a first subset of data points of the query EIC as the data points outside an intersection of data points between the reference EIC and the query EIC and a second subset of data points of the query EIC as the data points intersecting data points between the reference EIC and the query EIC, generating a scoring function value based on the first subset of data points, a scoring function value based on the second subset of data points, or both subsets of data points, iteratively repeating steps by shifting the data points of the query EIC by the plurality of time increments and generating a plurality of scoring function values, determining the optimal time increment that corresponds to the drift of the m/z signal feature by minimizing the first scoring function value, maximizing the second scoring function value, or both, and correcting the query EIC or the reference EIC by shifting the query EIC or the reference EIC by that time increment. In some embodiments, the compound is metabolites, isomers of metabolites, or both. In some embodiments, the chromatography-MS is liquid chromatography-MS.

In some embodiments, the reference EIC is a merged EIC of two or more EICs of the plurality of EICs and a remaining EIC is an individual EIC among the plurality of EICs. In another embodiment, the reference EIC is an individual EIC and a remaining EIC is an individual EIC among the plurality of EICs.

As methods of the instant disclosure comprise independently correcting drift in a plurality EICs of compounds bearing the same m/z value, in some embodiments, a method of the instant disclosure can further comprise identifying or having identified an m/z value most likely to belong to a compound for which an EIC can be extracted. In some embodiments, the m/z value most likely to belong to a compound is identified using methods described in International Application No. PCT/US2022/028150, the disclosure of which is incorporated herein in its entirety.

In some embodiments, the method further comprises obtaining or having obtained one or more data files from a chromatography-mass spectrometry machine that has analyzed one or more samples of unknown compounds, and splitting the MS chromatograms into a plurality of EICs each containing a mass-to-charge signal feature.

The scoring function serves as a component in the method for correcting drift in retention times of compound signals in chromatography-mass spectrometry data. The scoring function operates by evaluating the alignment of data points between a reference extracted ion chromatogram (EIC) and a query EIC that has been incrementally shifted by time increments. In some embodiments, the scoring function value is generated based on a sum of the first subset of data points. This subset of data points lies outside the intersection of data points between the reference EIC and the query EIC. In some embodiments, the method comprises generating a scoring function value based on the first subset of data points, determining the optimal time increment that corresponds to the drift of the m/z signal feature by minimizing the first scoring function value, and correcting the query EIC or the reference EIC by shifting the query EIC or the reference EIC by that time increment.

In some embodiments, the method further comprises using the scoring function value to determine if any pair of m/z signal features in an EIC are a compound and an isomer, a single isomer of the compound with drift, or noise or other artifacts. In some embodiments, the method further comprises using the scoring function value to determine if any pair of m/z signal features in an EIC are unique isomers or a single isomer of the compound with drift comprises comparing subsets of files high in any pair of two peaks, identifying symmetrical features within the scoring function that indicate poor fit in both directions of the time increments, and determining that symmetrical scoring function values indicate the presence of isomers rather than drift. In other embodiments, the method further comprises using the scoring function value to determine if any pair of m/z signal features in an EIC are unique isomers or a single isomer of the compound with drift comprises identifying the first m/z signal feature as a metabolite, determining the plurality of time increments that equally span both before and after the first m/z signal feature based on identifying the metabolite, incrementing through each time increment of the plurality of time increments to generate a scoring function, wherein the scoring function is generated from a plurality of scoring function values at each time increment, and determining the drift of the first m/z signal feature on a metabolite-by-metabolite basis by identifying a minimum scoring value in the scoring function. In some embodiments, the method further comprises using the scoring function value to determine if any pair of m/z signal features in an EIC are unique isomers or a single isomer of the compound with drift comprises determining a pair of scoring function values that correspond to symmetrical features within a scoring function, determining that the pair of scoring function values indicate a poor fit in both directions of the plurality of time increments, centered around the first m/z signal, and determining that the second m/z signal feature corresponds to an isomer rather than a drift in retention time based on the symmetrical features and poor fit in both directions.

In some embodiments, if it is determined that a second m/z signal feature is an isomer of a compound of the first m/z signal feature, the method further comprises excluding the isomer from the drift calculation and adjusting the compound peak and the isomer peak independently.

In some embodiments, the method further comprises determining a metric of similarity based on the scoring function. The metric can measure the probability that an optimal shift, which minimizes the average difference in the data points between the reference chromatogram and the query chromatogram, accurately represents the drift of the m/z signal feature rather than an isomer of a compound, or noise or other artifacts.

A method of the instant disclosure can further comprise addressing differential drift rates of isomers by creating subsets of the highest files with data in each isomer peak, comparing the signal distribution for each peak in the subsets to determine if the peaks are artifacts of drift, merging peaks by shifting the data points of one peak to align with another if they are determined to be the same compound experiencing drift, ensuring that the shift does not increase mismatches in signal and improves the metric of similarity, and iteratively assessing each pair of peaks to determine if they are artifacts of drift or unique isomers, where unique isomers will show signal in both subsets and merging them would worsen the metric of similarity.

According to yet another embodiment, the method further comprises generating query chromatograms for each m/z signal feature within the portion of the reference chromatogram and determining the time increment that corresponds to the drift of each m/z signal feature concurrently on different processors.

### II. Computing System

Another embodiment of the instant disclosure encompasses a computing system for overcoming drift in retention times of metabolite signals in MS. In some embodiments, the computing system is attached to and/or used in conjunction with a chromatography-MS system. The computing system can comprise several known components and circuitry, including a processor, a memory system, input and output devices and interfaces (e.g., an interconnection mechanism), as well as other components, such as transport circuitry (e.g., one or more busses), a video and audio data input/output (I/O) subsystem, special-purpose hardware, as well as other components and circuitry, as described below in more detail. Further, the computer system(s) can be a multi-processor computer system or can include multiple computers connected over a computer network.

A processor can include one or more general purpose computers, dedicated microprocessors, graphics processors, or other processing devices capable of communicating electronic information. Non-limiting examples of a processor include one or more application-specific integrated circuits (ASICs), graphical processing units (GPUs), field programmable gate arrays (FPGAs), graphics processing units (GPUs), digital signal processors (DSPs) and any other suitable specific or general purpose processors. The processor can be implemented as appropriate in hardware, firmware, or combinations thereof with computer-executable instructions and/or software. Computer-executable instructions and software can include computer-executable or machine-executable instructions written in any suitable programming language to perform the various functions described.

The memory can include more than one memory and can be distributed throughout the computing system. The memory can store program instructions that are loadable and executable on the processor(s) as well as data generated during the execution of these programs. Depending on the configuration and type of memory, the memory can be volatile (such as random access memory (RAM)) and/or non-volatile (such as read-only memory (ROM), flash memory, or other memory). In some embodiments, the memory can include multiple different types of memory, such as static random access memory (SRAM), dynamic random access memory (DRAM), or ROM.

In some embodiments, the computing system can also include additional storage, which can include removable storage and/or non-removable storage. The additional storage can include, but is not limited to, magnetic storage, optical disks, and/or solid-state storage. The disk drives and their associated computer-readable media can provide non-volatile storage of computer-readable instructions, data structures, program modules, and other data for the computing devices. The memory and the additional storage, both removable and non-removable, are examples of computer-readable storage media. For example, computer-readable storage media can include volatile or non-volatile, removable, or non-removable media implemented in any suitable method or technology for storage of information such as computer-readable instructions, data structures, program modules, or other data. As used herein, modules, engines, and components, can refer to programming modules executed by computing systems (e.g., processors) that are part of the architecture.

The processor generally manipulates the data within the integrated circuit memory element in accordance with the program instructions and then copies the manipulated data to the non-volatile recording medium after processing is completed. A variety of mechanisms are known for managing data movement between the non-volatile recording medium and the integrated circuit memory element, and the computing system that implements the methods, steps, systems control and system elements control described above is not limited thereto. The computing system is not limited to a particular memory system.

At least part of such a memory system described above can be used to store one or more data structures (e.g., look-up tables) or equations such as calibration curve equations. For example, at least part of the non-volatile recording medium can store at least part of a database that includes one or more of such data structures. Such a database can be any of a variety of types of databases, for example, a file system including one or more flat-file data structures where data is organized into data units separated by delimiters, a relational database where data is organized into data units stored in tables, an object-oriented database where data is organized into data units stored as objects, another type of database, or any combination thereof.

The computer implemented control system(s) can include one or more output devices. Non-limiting example output devices include a cathode ray tube (CRT) display, liquid crystal displays (LCD) and other video output devices, printers, communication devices such as a modem or network interface, storage devices such as disk or tape, and audio output devices such as a speaker.

The computing system also can include one or more input devices. Example input devices include a keyboard, keypad, track ball, mouse, pen and tablet, communication devices such as described above, and data input devices such as audio and video capture devices and sensors. The computing system is not limited to the particular input or output devices described herein.

It should be appreciated that one or more of any type of computing system can be used to implement various embodiments described herein. Aspects of the invention can be implemented in software, hardware or firmware, or any combination thereof. The computing system can include specially programmed, special purpose hardware, for example, an application-specific integrated circuit (ASIC). Such special-purpose hardware can be configured to implement one or more of the methods, steps, simulations, algorithms, systems control, and system elements control described above as part of the computer implemented control system(s) described above or as an independent component.

The computing system and components thereof can be programmable using any of a variety of one or more suitable computer programming languages. Such languages can include procedural programming languages, for example, LabView, C, Pascal, Fortran and BASIC, object-oriented languages, for example, C++, Java and Eiffel and other languages, such as a scripting language or even assembly language.

The methods, steps, simulations, algorithms, systems control, and system elements control can be implemented using any of a variety of suitable programming languages, including procedural programming languages, object-oriented programming languages, other languages and combinations thereof, which can be executed by such a computer system. Such methods, steps, simulations, algorithms, systems control, and system elements control can be implemented as separate modules of a computer program, or can be implemented individually as separate computer programs. Such modules and programs can be executed on separate computers.

Such methods, steps, simulations, algorithms, systems control, and system elements control, either individually or in combination, can be implemented as a computer program product tangibly embodied as computer-readable signals on a computer-readable medium, for example, a non-volatile recording medium, an integrated circuit memory element, or a combination thereof. For each such method, step, simulation, algorithm, system control, or system element control, such a computer program product can comprise computer-readable signals tangibly embodied on the computer-readable medium that define instructions, for example, as part of one or more programs, that, as a result of being executed by a computer, instruct the computer to perform the method, step, simulation, algorithm, system control, or system element control.

For clarity of explanation, in some instances the present technology can be presented as including individual functional blocks including functional blocks comprising devices, device components, steps or routines in a method embodied in software, or combinations of hardware and software.

Any of the steps, operations, functions, or processes described herein can be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program, or a collection of programs that carry out a specific function. In some embodiments, a service can be considered a server. The memory can be a non-transitory computer-readable medium.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions can be, for example, binaries, intermediate format instructions such as assembly language, firmware, or source code. Examples of computer-readable media that can be used to store instructions, information used, and/or information created during methods according to described examples include magnetic or optical disks, solid state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

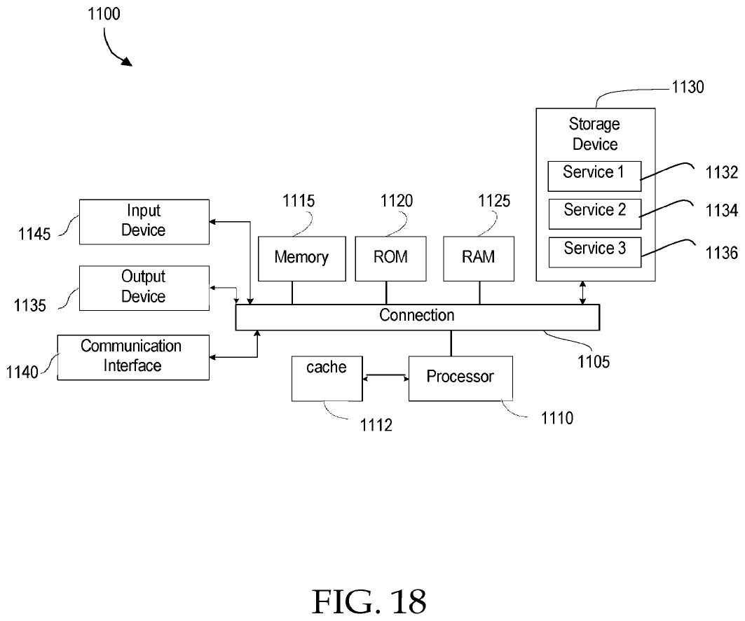

FIG. 18 shows an example of computing system 1800 in which the components of the system are in communication with each other using connection 1805. Connection 1805 can be a physical connection via a bus, or a direct connection into processor 1810, such as in a chipset architecture. Connection 1805 can also be a virtual connection, networked connection, or logical connection.

In some embodiments computing system 1800 is a distributed system in which the functions described in this disclosure can be distributed within a datacenter, multiple datacenters, a peer network, etc. In some embodiments, one or more of the described system components represents many such components each performing some or all of the function for which the component is described. In some embodiments, the components can be physical or virtual devices.

Example system 1100 includes at least one processing unit (CPU or processor) 1810 and connection 1805 that couples various system components including system memory 1815, such as read only memory (ROM) and random access memory (RAM) to processor 1810. Computing system 1800 can include a cache of high-speed memory connected directly with, in close proximity to, or integrated as part of processor 1810.

Processor 1810 can include any general purpose processor and a hardware service or software service, such as services 1832, 1834, and 1836 stored in storage device 1830, configured to control processor 1810 as well as a special-purpose processor where software instructions are incorporated into the actual processor design. Processor 1810 can essentially be a completely self-contained computing system, containing multiple cores or processors, a bus, memory controller, cache, etc. A multi-core processor can be symmetric or asymmetric.

To enable user interaction, computing system 1800 includes an input device 1845, which can represent any number of input mechanisms, such as a microphone for speech, a touch-sensitive screen for gesture or graphical input, keyboard, mouse, motion input, speech, etc. Computing system 1800 can also include output device 1835, which can be one or more of a number of output mechanisms known to those of skill in the art. In some instances, multimodal systems can enable a user to provide multiple types of input/output to communicate with computing system 1800. Computing system 1800 can include communications interface 1840, which can generally govern and manage the user input and system output. There is no restriction on operating on any particular hardware arrangement and therefore the basic features here can easily be substituted for improved hardware or firmware arrangements as they are developed.

Storage device 1830 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read only memory (ROM), and/or some combination of these devices.

The storage device 1830 can include software services, servers, services, etc., that when the code that defines such software is executed by the processor 1810, it causes the system to perform a function. In some embodiments, a hardware service that performs a particular function can include the software component stored in a computer-readable medium in connection with the necessary hardware components, such as processor 1810, connection 1805, output device 1835, etc., to carry out the function.

For clarity of explanation, in some instances the present technology can be presented as including individual functional blocks including functional blocks comprising devices, device components, steps or routines in a method embodied in software, or combinations of hardware and software.

Any of the steps, operations, functions, or processes described herein can be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program, or a collection of programs that carry out a specific function. In some embodiments, a service can be considered a server. The memory can be a non-transitory computer-readable medium.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions can be, for example, binaries, intermediate format instructions such as assembly language, firmware, or source code. Examples of computer-readable media that can be used to store instructions, information used, and/or information created during methods according to described examples include magnetic or optical disks, solid state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

One embodiment of the instant disclosure encompasses a computing system for correcting drift in retention times of compound signals in chromatography-mass spectrometry (chromatography-MS) data. The computing system of the instant disclosure comprises a communication interface and a processor. The communication interface can receive EICs of portions of each of a plurality of MS chromatograms, wherein the portions of the plurality of chromatograms bear the same m/z value. The processor can execute instructions stored in memory. In some embodiments, the processor executes the instructions to: (a) split a reference extracted ion chromatogram (EIC) of a portion of an MS chromatogram selected from a plurality of EICs into a plurality of time increments, wherein each of the plurality of EICs contains a mass-to-charge (m/z) signal feature that bears the same m/z value; (b) for each remaining EIC, generate a query EIC by shifting the data points of the query EIC by a first time increment of the plurality of time increments; (c) determine a first subset of data points of the query EIC as the data points outside an intersection of data points between the reference EIC and the query EIC and a second subset of data points of the query EIC as the data points intersecting data points between the reference EIC and the query EIC; (d) generate a scoring function value based on the first subset of data points, a scoring function value based on the second subset of data points, or both subsets of data points; (e) iteratively repeat steps (b) to (d) by shifting the data points of the query EIC by the plurality of time increments and generating a plurality of scoring function values; (g) determine the optimal time increment that corresponds to the drift of the m/z signal feature by minimizing the first scoring function value, maximizing the second scoring function value, or both; and (h) correct the query EIC or the reference EIC by shifting the query EIC or the reference EIC by that time increment.

In some embodiments, the reference EIC is a merged EIC of two or more EICs of the plurality of EICs and a remaining EIC is an individual EIC among the plurality of EICs. In other embodiments, the reference EIC is an individual EIC and a remaining EIC is an individual EIC among the plurality of EICs. Additionally, the compound can be metabolites, isomers of metabolites, or both. In some embodiments, the chromatography-MS is liquid chromatography-MS (LC-MS).

In some embodiments, the processor further executes the instructions to identify an m/z value most likely to belong to a compound for which an EIC can be extracted. The scoring function can be based on the sum of the first subset of data points.

In some embodiments, the processor further executes the instructions to: obtain one or more data files from a chromatography-mass spectrometry machine that has analyzed one or more samples of unknown compounds; and split the MS chromatograms into a plurality of EICs each containing a mass-to-charge (m/z) signal feature. The processor can executes the instructions to: generate a scoring function value based on the first subset of data points; determine the optimal time increment that corresponds to the drift of the m/z signal feature by minimizing the first scoring function value; and correct the query EIC or the reference EIC by shifting the query EIC or the reference EIC by that time increment.

In some embodiments, the processor further executes the instructions to use the scoring function value to determine if any pair of m/z signal features in an EIC are a compound and an isomer, a single isomer of the compound with drift, or noise or other artifacts. In some embodiments, the processor further executes the instructions to use the scoring function value to determine if any pair of m/z signal features in an EIC are unique isomers or a single isomer of the compound with drift by: comparing subsets of files high in any pair of two peaks; identifying symmetrical features within the scoring function that indicate poor fit in both directions of the time increments; and determining that symmetrical scoring function values indicate the presence of isomers rather than drift. In other embodiments, the processor further executes the instructions to use the scoring function value to determine if any pair of m/z signal features in an EIC are unique isomers or a single isomer of the compound with drift by: identifying the first m/z signal feature as a metabolite; determining the plurality of time increments that equally span both before and after the first m/z signal feature based on identifying the metabolite; incrementing through each time increment of the plurality of time increments to generate a scoring function, wherein the scoring function is generated from a plurality of scoring function values at each time increment; and determining the drift of the first m/z signal feature on a metabolite-by-metabolite basis by identifying a minimum scoring value in the scoring function.

In some embodiments, the processor further executes the instructions to use the scoring function value to determine if any pair of m/z signal features in an EIC are unique isomers or a single isomer of the compound with drift by: determining a pair of scoring function values that correspond to symmetrical features within a scoring function; determining that the pair of scoring function values indicate a poor fit in both directions of the plurality of time increments, centered around the first m/z signal; and determining that the second m/z signal feature corresponds to an isomer rather than a drift in retention time based on the symmetrical features and poor fit in both directions. The processor can further execute the instructions to exclude the isomer from the drift calculation and adjusting the compound peak and the isomer peak independently.

In some embodiments, the processor further executes the instructions to determine a metric of similarity based on the scoring function, wherein the metric measures the probability that an optimal shift, which minimizes the average difference in the data points between the reference chromatogram and the query chromatogram, accurately represents the drift of the m/z signal feature rather than an isomer of a compound, or noise or other artifacts. The processor can further execute the instructions to address differential drift rates of isomers by: creating subsets of the highest files with data in each isomer peak; comparing the signal distribution for each peak in the subsets to determine if the peaks are artifacts of drift; merging peaks by shifting the data points of one peak to align with another if they are determined to be the same compound experiencing drift, ensuring that the shift does not increase mismatches in signal and improves the metric of similarity; and iteratively assessing each pair of peaks to determine if they are artifacts of drift or unique isomers, where unique isomers will show signal in both subsets and merging them would worsen the metric of similarity.

In some embodiments, the processor further executes the instructions to generate query chromatograms for each m/z signal feature within the portion of the reference chromatogram and determining the time increment that corresponds to the drift of each m/z signal feature concurrently on different processors.

Yet another embodiment of the instant disclosure encompasses a non-transitory, computer-readable storage medium, having embodied thereon a program executable by a processor to perform a method for correcting drift in retention times of compound signals in chromatography-mass spectrometry (chromatography-MS) data. a method for correcting drift in retention times of compound signals in chromatography-mass spectrometry (chromatography-MS) data. The method comprises (a) splitting a reference extracted ion chromatogram (EIC) of a portion of an MS chromatogram selected from a plurality of EICs into a plurality of time increments, wherein each of the plurality of EICs contains a mass-to-charge (m/z) signal feature that bears the same m/z value; (b) for each remaining EIC, generating a query EIC by shifting the data points of the query EIC by a first time increment of the plurality of time increments; (c) determining a first subset of data points of the query EIC as the data points outside an intersection of data points between the reference EIC and the query EIC and a second subset of data points of the query EIC as the data points intersecting data points between the reference EIC and the query EIC; (d) generating a scoring function value based on the first subset of data points, a scoring function value based on the second subset of data points, or both subsets of data points; (e) iteratively repeating steps (b) to (d) by shifting the data points of the query EIC by the plurality of time increments and generating a plurality of scoring function values; (f) determining the optimal time increment that corresponds to the drift of the m/z signal feature by minimizing the first scoring function value, maximizing the second scoring function value, or both; and (g) correcting the query EIC or the reference EIC by shifting the query EIC or the reference EIC by that time increment.

The reference EIC can be a merged EIC of two or more EICs of the plurality of EICs and a remaining EIC is an individual EIC among the plurality of EICs. The reference EIC can also be an individual EIC and a remaining EIC is an individual EIC among the plurality of EICs.

In some embodiments, the compound is metabolites, isomers of metabolites, or both. In some embodiments, the chromatography-MS is liquid chromatography-MS (LC-MS). In some embodiments, the method further comprises identifying or having identified an m/z value most likely to belong to a compound for which an EIC can be extracted. In some embodiments, the scoring function is based on the sum of the first subset of data points.

In some embodiments, the method further comprises: obtaining or having obtained one or more data files from a chromatography-mass spectrometry machine that has analyzed one or more samples of unknown compounds; and splitting the MS chromatograms into a plurality of EICs each containing a mass-to-charge (m/z) signal feature.

In some embodiments, the method comprises: generating a scoring function value based on the first subset of data points; determining the optimal time increment that corresponds to the drift of the m/z signal feature by minimizing the first scoring function value; and correcting the query EIC or the reference EIC by shifting the query EIC or the reference EIC by that time increment.

In some embodiments, the method further comprises using the scoring function value to determine if any pair of m/z signal features in an EIC are a compound and an isomer, a single isomer of the compound with drift, or noise or other artifacts. In some embodiments, using the scoring function value to determine if any pair of m/z signal features in an EIC are unique isomers or a single isomer of the compound with drift comprises: comparing subsets of files high in any pair of two peaks; identifying symmetrical features within the scoring function that indicate poor fit in both directions of the time increments; and determining that symmetrical scoring function values indicate the presence of isomers rather than drift. In other embodiments, using the scoring function value to determine if any pair of m/z signal features in an EIC are unique isomers or a single isomer of the compound with drift comprises: identifying the first m/z signal feature as a metabolite; determining the plurality of time increments that equally span both before and after the first m/z signal feature based on identifying the metabolite; incrementing through each time increment of the plurality of time increments to generate a scoring function, wherein the scoring function is generated from a plurality of scoring function values at each time increment; and determining the drift of the first m/z signal feature on a metabolite-by-metabolite basis by identifying a minimum scoring value in the scoring function.

In some embodiments, using the scoring function value to determine if any pair of m/z signal features in an EIC are unique isomers or a single isomer of the compound with drift comprises: determining a pair of scoring function values that correspond to symmetrical features within a scoring function; determining that the pair of scoring function values indicate a poor fit in both directions of the plurality of time increments, centered around the first m/z signal; and determining that the second m/z signal feature corresponds to an isomer rather than a drift in retention time based on the symmetrical features and poor fit in both directions. In some embodiments, the method further comprises excluding the isomer from the drift calculation and adjusting the compound peak and the isomer peak independently.

A method of the instant disclosure can further comprise determining a metric of similarity based on the scoring function, wherein the metric measures the probability that an optimal shift, which minimizes the average difference in the data points between the reference chromatogram and the query chromatogram, accurately represents the drift of the m/z signal feature rather than an isomer of a compound, or noise or other artifacts.

In some embodiments, the method further comprises addressing differential drift rates of isomers by: creating subsets of the highest files with data in each isomer peak;
comparing the signal distribution for each peak in the subsets to determine if the peaks are artifacts of drift; merging peaks by shifting the data points of one peak to align with another if they are determined to be the same compound experiencing drift, ensuring that the shift does not increase mismatches in signal and improves the metric of similarity; and iteratively assessing each pair of peaks to determine if they are artifacts of drift or unique isomers, where unique isomers will show signal in both subsets and merging them would worsen the metric of similarity.

In some embodiments, the method further comprises generating query chromatograms for each m/z signal feature within the portion of the reference chromatogram and determining the time increment that corresponds to the drift of each m/z signal feature concurrently on different processors.

Although a variety of examples and other information was used to explain embodiments within the scope of the appended claims, no limitation of the claims should be implied based on particular features or arrangements in such examples, as one of ordinary skill would be able to use these examples to derive a wide variety of implementations. Further and although some subject matter can have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

### Definitions

Unless defined otherwise, all technical and scientific terms used herein have the meaning commonly understood by a person skilled in the art to which this invention belongs. The following references provide one of skill with a general definition of many of the terms used in this invention: Singleton et al., Dictionary of Microbiology and Molecular Biology (2nd ed. 1994); The Cambridge Dictionary of Science and Technology (Walker ed., 1988); The Glossary of Genetics, 5th Ed., R. Rieger et al. (eds.), Springer Verlag (1991); and Hale & Marham, The Harper Collins Dictionary of Biology (1991). As used herein, the following terms have the meanings ascribed to them unless specified otherwise.

When introducing elements of the present disclosure or the preferred aspects(s) thereof, the articles “a”, “an”, “the” and “said” are intended to mean that there are one or more of the elements. The terms “comprising”, “including” and “having” are intended to be inclusive and mean that there can be additional elements other than the listed elements.

As various changes could be made in the above-described cells and methods without departing from the scope of the invention, it is intended that all matter contained in the above description and in the examples given below, shall be interpreted as illustrative and not in a limiting sense.

1. A method for correcting drift in retention times of compound signals in chromatography-mass spectrometry (chromatography-MS) data, the method comprising:
a. splitting a reference extracted ion chromatogram (EIC) selected from a plurality of EICs into a plurality of time increments, wherein each EIC of the plurality of EICs contains a mass-to-charge (m/z) signal feature having the same m/z value;
b. for each remaining EIC, shifting data points of the remaining EIC by a first time increment of the plurality of time increments to generate a query EIC;
c. determining, for the query EIC, a non-overlapping subset of data points comprising data points lying outside an intersection between the reference EIC and the query EIC and an overlapping subset of data points comprising data points of the query EIC that overlap with data points of the reference EIC;
d. generating a scoring function value based on the non-overlapping subset of data points, the overlapping subset of data points, or both subsets of data points;
e. iteratively repeating steps (b) to (d) for each of the plurality of time increments to generate a plurality of scoring function values;
f. determining an optimal time increment that corresponds to the drift of the m/z signal feature by minimizing the scoring function value based on the non-overlapping subset of data points, maximizing the scoring function value based on the overlapping subset of data points, or both; and
g. correcting the query EIC by shifting the query EIC by the optimal time increment.

2-3. (canceled)

4. The method of claim 1, wherein the compound is metabolites, isomers of metabolites, or both.

5. (canceled)

6. The method of claim 1, further comprising identifying or having identified an m/z value most likely to belong to a compound for which an EIC can be extracted.

7. The method of claim 1, wherein the optimal time increment is determined by minimizing the scoring function value generated based on the non-overlapping subset of data points.

8-9. (canceled)

10. The method of claim 1, further comprising using the scoring function value to determine whether a pair of m/z signal features in a merged EIC generated from the plurality of EICs corresponds to distinct isomers or to a single isomer split by retention time drift.

11. The method of claim 1, wherein using the scoring function value to determine whether the pair of m/z signal features corresponds to distinct isomers or to single isomer split by retention time drift comprises:
a. comparing a first subset of files having high signal for a first peak with a second subset of files having high signal for a second peak; and
b. determining that the first peak and the second peak correspond to a single isomer split by retention time drift when signals for the first peak and the second peak are mutually exclusive between the first subset of files and the second subset of files, or determining that the first peak and the second peak correspond to distinct isomers when signals for both peaks are present in the first subset of files and in the second subset of files

12. The method of claim 10, wherein using the scoring function value to determine whether the pair of m/z signal features corresponds to distinct isomers or to a single isomer split by retention time drift comprises:
a. identifying a first m/z signal feature;
b. determining a plurality of time increments spanning before and after the first m/z signal feature;
c. incrementing through each time increment of the plurality of time increments to generate a scoring function, wherein the scoring function is generated from a plurality of scoring function values at respective time increments; and
d. determining, for the first m/z signal feature, drift in retention time by identifying a minimum scoring value in the scoring function.

13. The method of claim 1, wherein using the scoring function value to determine whether the pair of m/z signal features corresponds to distinct isomers or to a single isomer split by retention time drift comprises:
a. determining a pair of scoring function values corresponding to symmetrical features within a scoring function;
b. determining that the pair of scoring function values indicate a poor fit in both directions of the plurality of time increments, centered around the first m/z signal feature; and
c. determining that the second m/z signal feature corresponds to an a distinct isomer rather than a drift in retention time based on the symmetrical features and the poor fit in both directions.

14. The method of any one of claims 5-9, further comprising excluding the distinct isomer from the drift calculation and adjusting the first peak and the second peak independently.

15. The method of claim 1, further comprising determining based on the scoring function, a metric of similarity that indicates whether an optimal shift which minimizes the average difference in the data points between the reference chromatogram and the query chromatogram represents drift of the m/z signal feature rather than an isomer.

16. The method of claim 15, further comprising addressing differential drift rates of isomers by:
a. creating a first subset and a second subset of the highest files with data in a first isomer peak and a second isomer peak, respectively;
b. comparing the signal distribution for each peak in the subsets to determine if the peaks are a single isomer split by retention time drift or distinct isomers;
c. merging peaks by shifting the data points of one peak to align with another if they are determined to be the single isomer split by retention time drift, ensuring that the shift does not increase mismatches in signal and improves the metric of similarity; and
d. iteratively assessing each pair of peaks to determine if they are a single isomer split by retention time drift or distinct isomers, where distinct isomers will show signal in both subsets and merging them would worsen the metric of similarity.

17. The method of claim 1, further comprising generating query EICs for each m/z signal feature within the portion of the reference chromatogram and determining, concurrently on different processors, the time increment that corresponds to the drift of each m/z signal feature.

18. A computing system for correcting drift in retention times of compound signals in chromatography-mass spectrometry (chromatography-MS) data, the system comprising:
a. a communication interface that receives EICs of portions of each of a plurality of MS chromatograms, wherein the portions of the plurality of chromatograms bear the same m/z value; and
b. a processor that executes instructions stored in memory, wherein the processor executes the instructions to:
i. split a reference extracted ion chromatogram (EIC) selected from a plurality of EICs into a plurality of time increments, wherein each EIC of the plurality of EICs contains a mass-to-charge (m/z) signal feature having the same m/z value;
ii. for each remaining EIC, shift data points of the remaining EIC by a first time increment of the plurality of time increments to generate a query EIC;
iii. determining, for the query EIC, a non-overlapping subset of data points comprising data points lying outside an intersection between the reference EIC and the query EIC and an overlapping subset of data points comprising data points of the query EIC that overlap with data points of the reference EIC;
iv. generate a scoring function value based on the non-overlapping subset of data points, the overlapping subset of data points, or both subsets of data points;
v. iteratively repeat steps (ii) to (iv) for each of the plurality of time increments to generate a plurality of scoring function values;
vi. determine an optimal time increment that corresponds to the drift of the m/z signal feature by minimizing the scoring function value based on the non-overlapping subset of data points, maximizing the scoring function value based on the overlapping subset of data points, or both; and
vii. correct the query EIC by shifting the query EIC by the optimal time increment.

19-34. (canceled)

35. A non-transitory, computer-readable storage medium, having embodied thereon a program executable by a processor to perform a method for correcting drift in retention times of compound signals in chromatography-mass spectrometry (chromatography-MS) data, the method comprising:
a. splitting a reference extracted ion chromatogram (EIC) selected from a plurality of EICs into a plurality of time increments, wherein each EIC of the plurality of EICs contains a mass-to-charge (m/z) signal feature having the same m/z value;
b. for each remaining EIC, shifting data points of the remaining EIC by a first time increment of the plurality of time increments to generate a query EIC;
c. determining, for the query EIC, a non-overlapping subset of data points comprising data points lying outside an intersection between the reference EIC and the query EIC and an overlapping subset of data points comprising data points of the query EIC that overlap with data points of the reference EIC;
d. generating a scoring function value based on the non-overlapping subset of data points, the overlapping subset of data points, or both subsets of data points;
e. iteratively repeating steps (b) to (d) for each of the plurality of time increments to generate a plurality of scoring function values;
f. determining an optimal time increment that corresponds to the drift of the m/z signal feature by minimizing the scoring function value based on the non-overlapping subset of data points, maximizing the scoring function value based on the overlapping subset of data points, or both; and
g. correcting the query EIC by shifting the query EIC by the optimal time increment.

36-51. (canceled)

52. The method of claim 8, wherein the pair of m/z signal features is evaluated in a chromatogram comprising a first peak, a second peak, and a third peak, and wherein swapping the second peak with the first peak or with the third peak produces a symmetric score distribution in the scoring function, thereby indicating that the third peak corresponds to a distinct isomer and is excluded from drift calculation.
